(19) United States
(12) Patent Application Publication
(10) Pub. No.: US 2007/0038924 A1
(43) Pub. Date: Feb. 15, 2007

(54) Methods and systems for placing card orders

(76) Inventors: Darren Beyer, Winter Park, FL (US); Laurence Dunne, Tamarac, FL (US); Monica Tan, Palo Alto, CA (US)

Correspondence Address: MICHAEL BEST & FRIEDRICH, LLP, 100 E WISCONSIN AVENUE, MILWAUKEE, WI, 53202, US

(21) Appl. No.: 11/503,417

(22) Filed: Aug. 11, 2006

Related U.S. Application Data
(60) Provisional application No. 60/707,565, filed on Aug. 11, 2005.

(51) Int. Cl. G06F 17/00

(52) U.S. Cl. 715/507

(57) ABSTRACT

Methods and systems for processing an order for at least one card. One method can include electronically receiving a request for an order form file from a client computer; electronically transmitting the order form file to the client computer; electronically receiving the order form file from the client computer, the order form file including data defining an order for at least one card; automatically validating the data included in the order form file; and automatically processing the data to fulfill the order.

### RELATED APPLICATIONS

The present patent application claims priority to U.S. Provisional Patent Application Ser. No. 60/707,565 filed on Aug. 11, 2005, the entire contents of which is herein incorporated by reference.

### BACKGROUND OF THE INVENTION

Embodiments of the invention provide methods and systems for placing card orders. In particular, embodiments of the invention provide methods and systems for placing card orders for a plurality of cards electronically over a network, such as the Internet.

Stored-value cards can be used as a substitute for cash, gift certificates, and check payments. Monetary value can be added to a stored-value account associated with a stored value account before the card is used, with the value either being funded by the cardholder directly or by the card program operator in commercial applications.

Typically, manual work is required, both at a card processing system and by the client, in order to place an order for one or more cards. For example, to order personalized gift cards in bulk, a program administrator typically must code an order to batch file specifications set by the card processing system, which is often not optimal due to development costs and time delays and often involve substantial human manipulation both by the client and at the card processing system before batch order files or data are created and ready for automatic processing.

### SUMMARY OF THE INVENTION

Embodiments of the invention provide methods of processing an order for at least one card. One method can include electronically receiving a request for an order form file from a client computer; electronically transmitting the order form file to the client computer; electronically receiving the order form file from the client computer, the order form file including data defining an order for at least one card; automatically validating the data included in the order form file; and automatically processing the data to fulfill the order.

Additional embodiments provide systems for processing an order for at least one card. One system can include a card processing system. The card processing system can be configured to electronically receive registration information for a user from a client computer; to electronically receive an order form file from the client computer, the order form file including data defining an order from the user for at least one card; to automatically process the data to fulfill the order; and to use the registration information in a subsequent order placed by the user.

Further embodiments also provide computer readable media including instructions for processing an order for at least one card. One computer readable medium can include instructions for receiving a request for an order form file from a client computer; transmitting the order form file to the client computer; receiving the order form file from the client computer, the order form file including data defining an order for at least one card; approving the order; and automatically processing the data to fulfill the order.

### BRIEF DESCRIPTION OF THE DRAWINGS

FIG. 1A illustrates an order placement system according to one embodiment of the invention.

FIGS. 1B and 1C illustrate an order form according to one embodiment of the invention.

FIG. 2 illustrates a process of ordering cards using the order placement system of FIG. 1A according to one embodiment of the invention.

FIGS. 3-36 illustrate various screens, pages, and forms displayed by a consumer-based ordering website according to embodiments of the invention.

FIGS. 37-55 illustrate various screens, pages, and forms displayed by a business-to-business ordering application according to embodiments of the invention.

FIG. 56 illustrates three possible ordering scenarios for ordering cards using the card processing system of FIG. 1A according to embodiments of the invention.

FIG. 57 illustrates a process of ordering cards using a consumer-based ordering website according to one embodiment of the invention.

FIG. 58 illustrates a process of registering with a card processing system and downloading an order form using a consumer-based ordering website according to one embodiment of the invention.

FIG. 59 illustrates a process of placing an order using a consumer-based ordering website according to one embodiment of the invention.

FIG. 60 illustrates a process of uploading an order form using a consumer-based ordering website according to one embodiment of the invention.

FIG. 61 illustrates a process of approving an order using a business-to-business ordering application according to one embodiment of the invention.

FIG. 62 illustrates a process of processing an order using the card processing system of FIG. 1A according to one embodiment of the invention.

FIG. 63 illustrates a process of ordering cards using a business-to-business ordering application according to one embodiment of the invention.

FIG. 64 illustrates a process of registering with a card processing system and placing an order using a business-to-business ordering application according to one embodiment of the invention.

FIG. 65 illustrates a process of uploading an order form using a business-to-business ordering application according to one embodiment of the invention.

FIG. 66 illustrates a process of approving an order using a business-to-business ordering application according to one embodiment of the invention.

FIG. 67 illustrates a process of checking the status of an order using a business-to-business ordering application according to one embodiment of the invention.

FIGS. 68-81 illustrate configuration guide forms according to embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, can be illustrated and described as if the majority of the components were implemented solely in hardware. However, one of ordinary skill in the art, and based on a reading of this detailed description, would recognize that, in at least one embodiment, the electronic based aspects of the invention can be implemented in software. As such, it should be noted that a plurality of hardware and software based devices, as well as a plurality of different structural components can be utilized to implement the invention. Furthermore, and as described in subsequent paragraphs, the specific configurations illustrated in the drawings are intended to exemplify embodiments of the invention and that other alternative configurations are possible.

Embodiments of the invention provide an order placement system. In some embodiments, the order placement system can be used to create and order personalized and non-personalized (i.e., anonymous) cards, such as stored value cards, greeting cards, identification cards, credit cards, debit cards, etc., individually or in bulk. The cards can include magnetic swipe cards, smart cards, transponders, radio frequency identification cards, or any other type of presentation device that is used to identify a user and/or an account. In some embodiments, the order placement system can also be used to initially load value to newly-ordered or existing cards. It should be understood that the order placement system can also be used to order replacement or additional cards associated with one card account, order sub-account or dependent cards associated with a previously-established parent card account, change a card's status, load funds to pre-existing cards, etc.

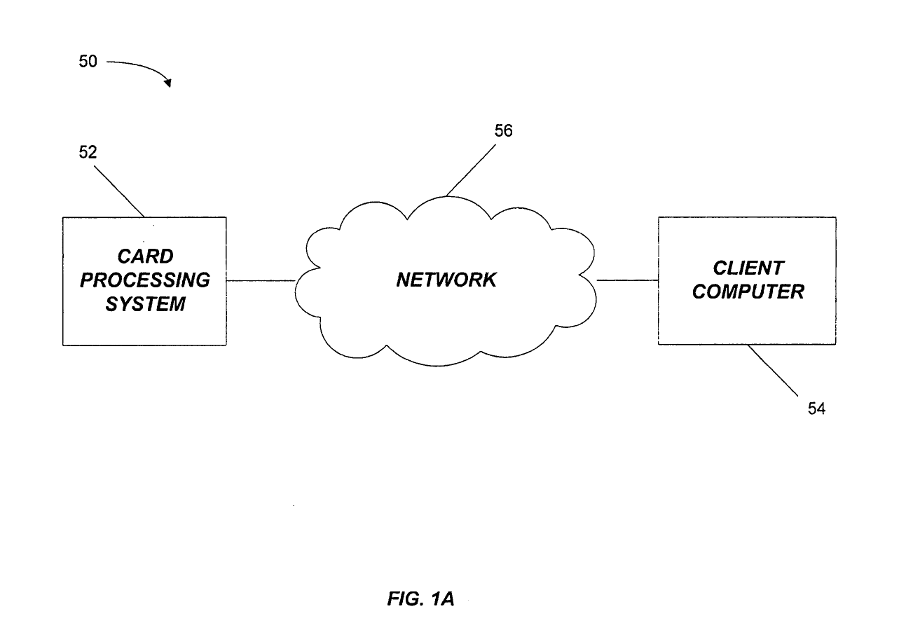

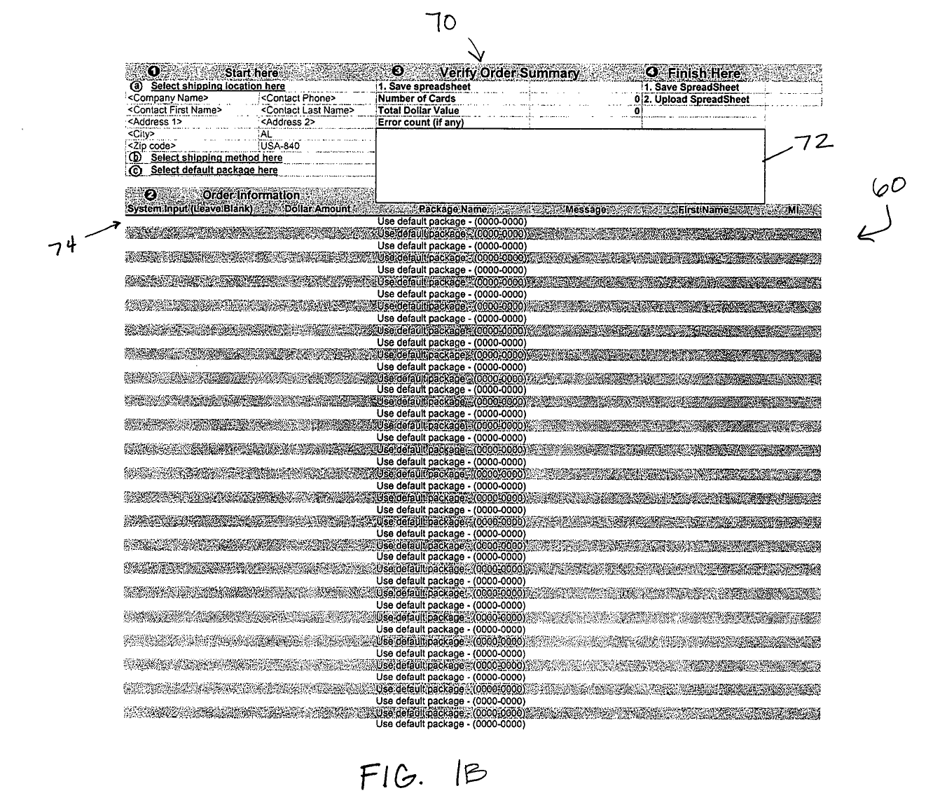

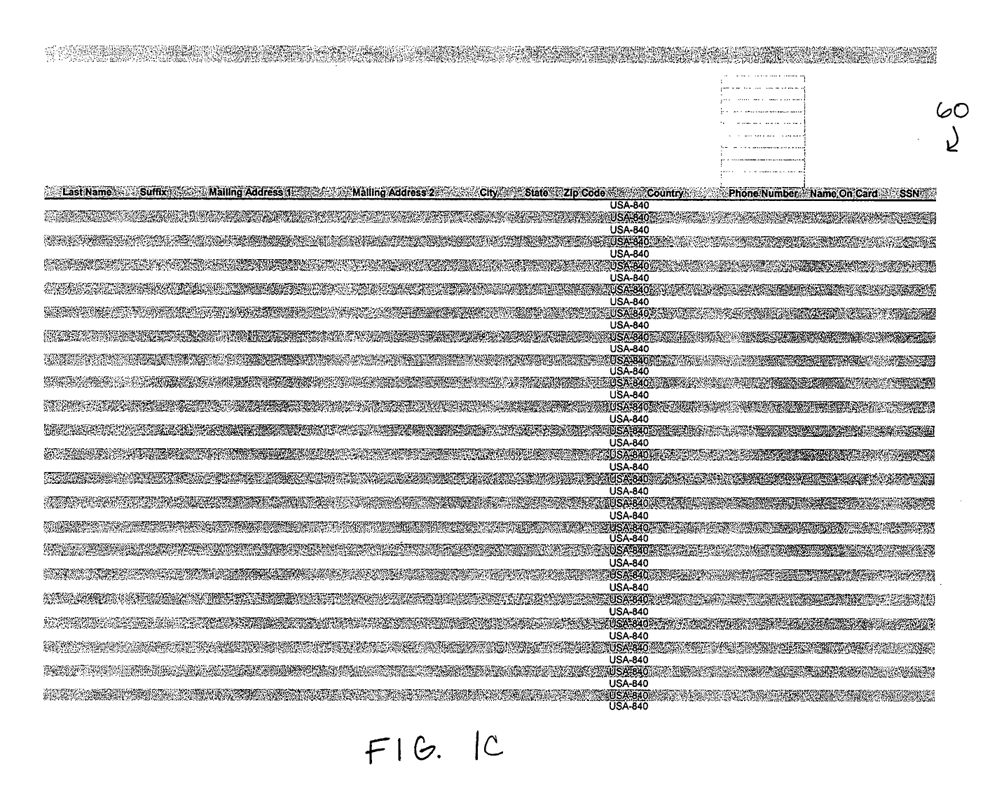

FIG. 1 illustrates an order placement system 50 according to one embodiment of the invention. As shown in FIG. 1, the system 50 includes a card processing system 52 and a client computer 54. The card processing system 52 is connected to the client computer 54 by a connection or network 56. The network 56 can include one or more networks, such as a local area network and/or the Internet. In some embodiments, the client computer 54 can access the card processing system 52 via an application executed by the client computer 54. The application can include a general purpose application (e.g., a browser application), a proprietary application specifically programmed to interface and communicate with the card processing system 52, or a combination thereof.

In some embodiments, a user can use the client computer 54 to access order placement pages or forms provided by the card processing system 52 (e.g., via a server included in the card processing system 52) that the user can use to submit order information to the card processing system 52. It should be understood that although only one client computer 54 is shown connected to the card processing system 52 in FIG. 1A, multiple client computers 54 can be connected to the card processing system via one or more networks or connections.

When the card processing system 52 receives order information from the client computer 54, the card processing system 52 can automatically process the order with little or no manual intervention. In some embodiments, the card processing system 52 includes multiple devices or systems, such as servers, databases, etc. The card processing system 52 can also interact with one or more third-party devices or systems (e.g., a card fulfillment system, a financial institution system, etc.) in order to process an order.

In some embodiments, the card processing system 52 can provide a downloadable order form file, such as an Excel spreadsheet file, that a user can use to provide an order to the system 52. The order form can include customizable optional areas and/or required areas. Using the client computer 54 (e.g., a personal computer), a user can access the order form from the card processing system 52 (e.g., a web server included in the card processing system 52). Once the user accesses the card processing system 52, the user can obtain (e.g., download) a copy of the order form. In some embodiments, the copy of the order form downloaded by a user can be condensed (e.g., zipped) so that the user can more easily obtain a copy. The user can fill in the order form with order information (e.g., using the client computer 54) and can upload or provide the completed order form to the card processing system 52. The card processing system 52 can then automatically process the uploaded order form in order to complete the order.

FIGS. 1B and 1C illustrate a downloadable order form 60 provided by the card processing system 52 according to one embodiment of the invention. In some embodiments, the order form 60 can include locked columns, rows, and/or cells or fields. For example, columns of the order form 60 can be locked in place such that they cannot be “scrolled” off a screen or monitor of the client computer 54. Columns of the order form 60 can also be locked so that error messages and/or values associated with an order are visible to a user regardless of which portion of the order form 60 the user is currently viewing or working with. Similarly, rows of the order form 60 can be locked so that headings of the order form 60 are visible to a user regardless of which portion of the order form 60 the user is currently viewing or working with. Columns, rows, and/or cells or fields of the order form 60 can also be hidden if they are not to be used by a user. Columns, rows, and/or cells or fields of the order form 60 that include read-only information or other information used by the card processing system 52 or the order form 60 to process the order form 60 (e.g., to validate the information entered into the order form 60) can also be locked and/or hidden in the order form 60. In some embodiments, the order form 60 can also include reserved columns, rows, and/or cells or fields that are reserved for configuration information, such as allowable inputs for particular cells or fields of the order form 60 (e.g., allowable packages, shipping methods, country names, state names, etc.).

The order form 60 can include one or more validation mechanisms, such as macros or preprogrammed scripts, for performing various validation functions. For example, the order form 60 can include a macro that includes code or a script that executes on a “save” event (e.g., when a user selects “save” or “save as” from a file menu, when a user selects a save (e.g., a diskette) icon, or when a user presses a certain key or a combination of keys (e.g., CTRL+S) in order to save the order form 60). Executing the macro can perform data validation routines for selected cells or fields of the order form 60. In some embodiments, the order form 60 can also be pre-programmed with error checks built directly into specified cells or fields of the order form 60 that can be triggered when data is entered in the cells or fields.

A user can use the order form 60 to create and order personalized cards and/or non-personalized cards. In some embodiments, personalized cards can be personalized with a particular denomination, a recipient's name, and/or a customized message. Non-personalized cards can be ordered with a default name, customized message, and/or denomination. In some embodiments, a user can use the order form 60 to create and order personalized cards and can use a website provided by the card processing system 52, as described below, to create and order non-personalized cards. The website provided by the system 52 can prompt the user to enter information similar to the information entered in the order form 60.

As shown in FIG. 1B, using the order form 60 (or a website provided by the card processing system 52), a user can select a shipping location for an order. For example, to select a shipping location, a user can select (e.g., click on) a cell, field, or other selection mechanism labeled “Select shipping location here” included in the order form 60 (see FIG. 1A) and can use a drop-down arrow (or other selection mechanism) included in the order form 60 to select a particular shipping location. For personalized orders, a shipping location can include an individually shipped selection (i.e., each card is shipped to the recipient address), an address on file selection (i.e., all cards are shipped to the address on file with the card processing system 52 or another system, such as a financial institution system), or a bulk ship address selection (i.e., all cards are shipped to the address specified in the order form 60). As shown in FIG. 1B, the user can also input a shipping location using the order form 60. For example, if the user selects the bulk ship address selection, the user can enter the shipping location (e.g., name and address) that all of the ordered cards should be shipped to in the order form 60. The user can also specify additional information for a shipping location, such as information about a contact person at the shipping location using the order form 60.

The user can also use the order form 60 to select a shipping method by selecting a selection mechanism labeled “Select shipping method here” included in the order form 60 and using a drop-down arrow or similar selection mechanism included in the order form 60 to select a particular shipping method. In some embodiments, a user can select a regular shipping method (i.e., cards are shipped through regular mail) or an express shipping method (i.e., cards are shipped using express delivery) using the order form 60.

After selecting a shipping method, a user can select a default package for an order using the order form 60 by selecting a selection mechanism labeled “Select the default package here” included in the order form 60 and using a drop-down arrow or similar selection mechanism included in the order form 60 to select a desired default package. The default package can define a default or base design or configuration for cards ordered using the order form 60. A card package can define a card design including graphics, embossing rules, association bugs (e.g., logos), magnetic stripe materials, etc.

In some embodiments, the selected default package can be automatically applied to each card ordered using the order form 60. A user, however, can select a different package or design for a particular card ordered using the order form 60 by indicating or selecting a different package in the column labeled “Package Name” for a particular line item of the order form 60.

After selecting a shipping selection, a shipping method, and/or a default package for an order, a user can enter order information into the order form 60. A user can manually enter order information into the order form 60 or can copy or load information from another source (e.g., another order form or spreadsheet, a database, etc.) into the order form 60. In some embodiments, order information can include a dollar or value amount for a card. The value amount specifies an amount of funds or other value (e.g., points, uses, credits, etc.) that are accessible with a card (e.g., a stored value card). Order information can also include a package name for each card. As noted above, a package can define the base design or configuration for a particular card. In some embodiments, a user can enter a package name for a card only if the user would like the package for the card to differ from the selected default package for the order.

Order information can also include a message to be displayed on a card, such as “Congratulations” or “Happy Holidays.” A message can be optional. In addition, order information can include a prefix (e.g., Mr., Miss., etc.) of the card recipient, a first name of the card recipient, a middle initial of the card recipient, a last name of the card recipient, and/or a suffix of the card recipient. The recipient's first name and last name can be required. The middle initial of the recipient can be optional, and, if the recipient does not have a middle initial, the user can leave the cell or field of the order form 60 associated with a recipient's middle initial blank. Similarly, the recipient's prefix or suffix can be optional, and the user can leave the cell or field associated with a recipient's prefix or suffix blank if the recipient's name does not have a prefix or a suffix. In some embodiments, order information can also include the recipient's social security number.

In addition, order information can include the card recipient's mailing address. The recipient's mailing address can include a first line and a second line. A first line of the recipient's mailing address can be required, and a second line of the recipient's mailing address can be optional and can be used for additional address information, such as an apartment number or a suite number. The mailing address can also include the recipient's city, state (e.g., a two letter state code), and zip code.

Optionally, the order information can include the card recipient's name as it should appear on the card. If this cell or field of the order form 60 is left blank in the order form 60 for a particular line item, the recipient's first name, middle initial, last name, and/or suffix can be used as the recipient's name included on the card. Order information can also include the recipient's telephone number and/or email address.

As shown in FIGS. 1B and 1C, each line item included in the order form 60 can include a validation or “System Input” cell or field 74. The validation field 74 can display any errors that occur when data included in the line item is validated (e.g., by macros and/or other error-checks included in the order form 60). In some embodiments, if a particular line item of the order form 60 is free of errors, the validation field 74 associated with the line item can display “Validated” or a similar message indicating that the line item contains no errors identified by the macros or error-checks.

As shown in FIG. 1B, the order form 60 can include a summary section 70. The summary section 70 can display totals for the order form 60, such as a total number of cards ordered, a total dollar or value amount for the cards ordered, a total number of errors, etc. It should be understood that although the order form 60 shown in FIGS. 1B and 1C includes a limited number of line items, in some embodiments, a user can add additional lines to the order form 60 as needed. As also shown in FIG. 1B, the order form 60 can also include one or more customizable sections 72. In some embodiments, the customizable sections 72 can include a logo or other marketing material, which can be tailored to the user of the order form 60.

After entering the order information into the order form 60, a user can save the order form 60. In some embodiments, a user can save the order form 60 by selecting a “file” menu, selecting a “save as . . . ” option from the “file” menu, naming the order form 60, and selecting a “Save” button or other type of selection mechanism. As described above, in some embodiments, macros and/or error-checks, included in the order form 60, can check for errors in the order form 60 when the order form 60 is saved and/or when data is entered into the order form 60. In some embodiments, if one or more errors are identified in an order form when the order form 60 is saved, an error dialog box can be displayed (e.g., by the client computer 54). The error dialog box can indicate the one or more errors identified in the order form 60 and/or can indicate how errors are marked or identified in the order form 60. For example, the error dialog box can indicate that errors in the order form are highlighted in yellow. A user can then locate and fix the identified errors in the order form 60 and can re-save the form 60. In some embodiments, even if one or more errors are identified in an order form, the client computer 54 can save the order form 60. Macros associated with the order form can be enabled or disabled.

Once the order form 60 has been saved and error-checked (optional), a user can upload the order form 60 to the card processing system 52. To upload the order form 60, a user can access a particular network location (e.g., a website of the card processing system 52). In some embodiments, the website can include one or more selection or input mechanisms that the user can use to select or specify that they want to upload an order form 60. For example, a user can select an upload button or other type of selection mechanism included in the website in order to specify that they have an order form 60 to upload to the card processing system 52. The user can then specify the name and location of a saved order form (e.g., the full path name of an order form saved on the client computer 52 or on an accessible external device or system) or select a saved order form from a list of available files. After selecting or specifying the saved order form, the card processing system 52 can upload and receive the specified form. In some embodiments, the system 52 can error-check an order form during the upload process. If errors are identified in an order form during the upload process, the system 52 can inform the user of the errors and can instruct the user to correct the errors and re-upload the order form. In some embodiments, the card processing system 52 prevents an order form from being uploaded if it contains errors. If no errors are identified during the upload process, the system 52 can prompt the user to verify and submit the order form for processing. In some embodiments, the user can cancel the upload process at this point without uploading the order form to the system 52.

In some embodiments, as described below, another individual (e.g., a different individual than the user who entered the order) can approve an order before it is submitted for processing by the card processing system 52. For example, a user (e.g., associated with a financial institution or other organization) can access uploaded order forms (e.g., through a module or application included the card processing system 52) in order to review and approve or reject submitted orders. As described below, in some embodiments, a user can approve an order once a user provides a payment for an order.

The card processing system 52 automatically processes the order information included in an uploaded order form. In some embodiments, the card processing system 52 converts the order information included in an uploaded order form to a batch file according to batch file specifications (e.g., a comma separate file) and then processes the batch file. Processing the batch file can include recording batch data in a new batch database, running a batch process, recording results in a batch table, and triggering messages to be sent to one or more locations in order to signal processing of an order is complete. Processing the batch file can also include creating accounts associated with the ordered cards.

In some embodiments, after uploading an order form, a user can check the status of the order by accessing the card processing system 52 (e.g., via a website), providing credentials (e.g., logging into the website), and searching or querying for a particular order. In some embodiments, an order can have a status of “Submitted,” “In Progress,” “Complete with errors,” or “Complete without errors.”

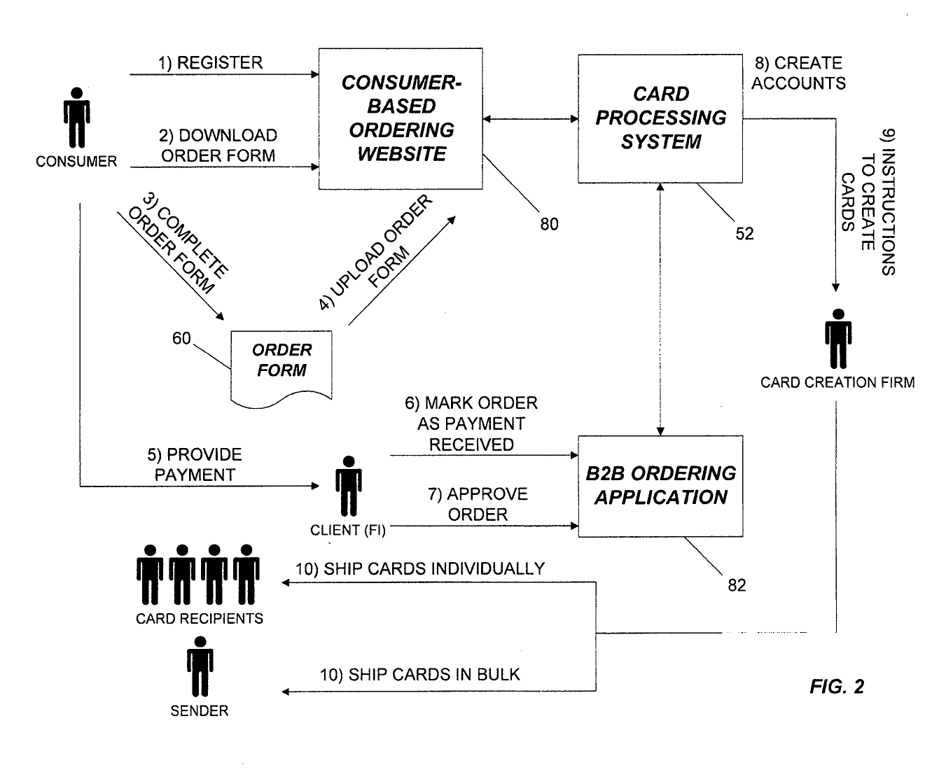

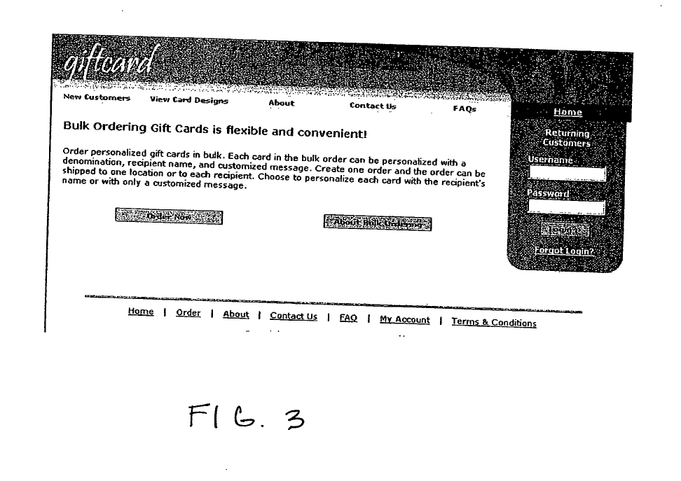

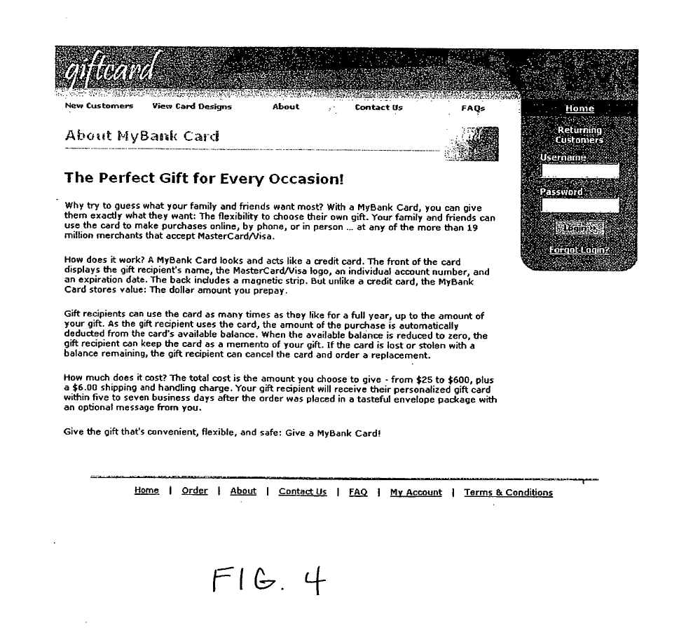

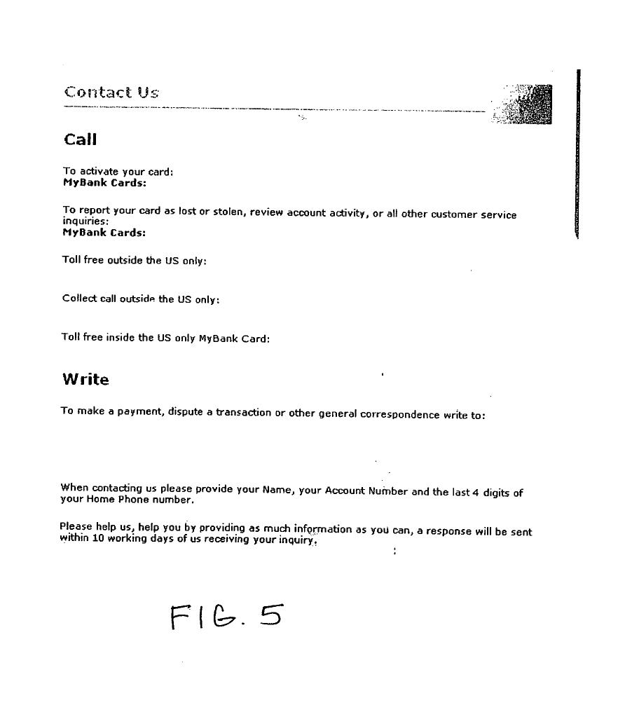

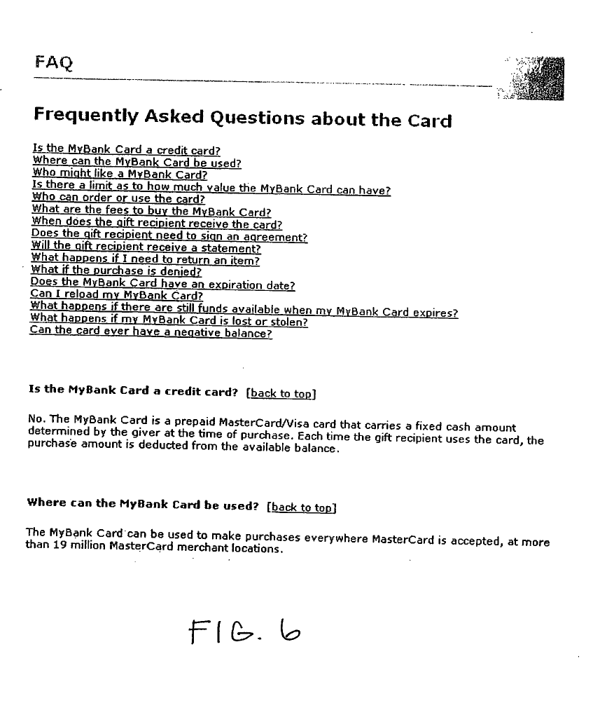

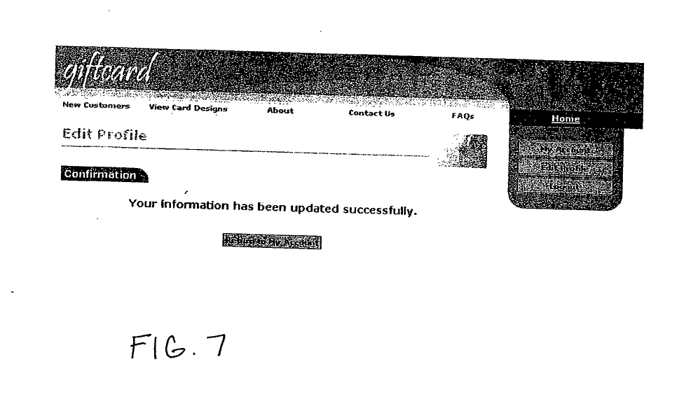

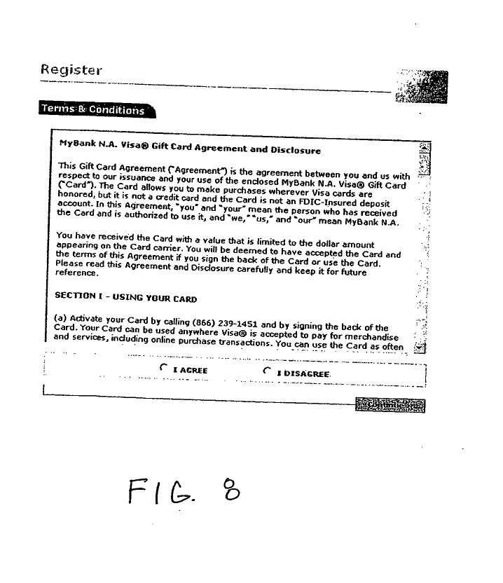

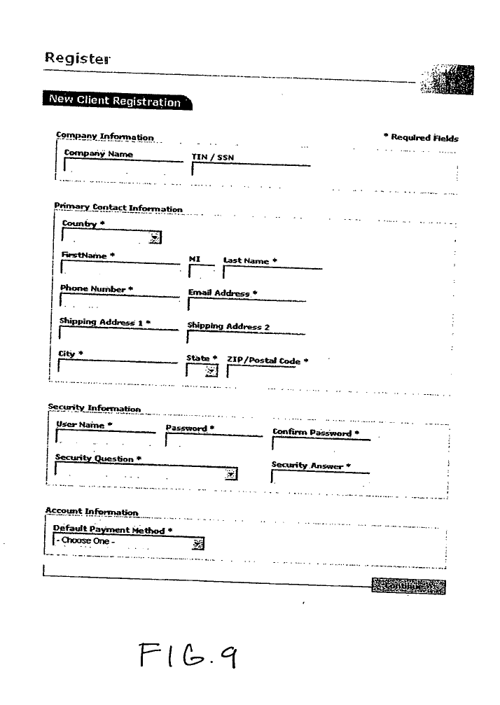

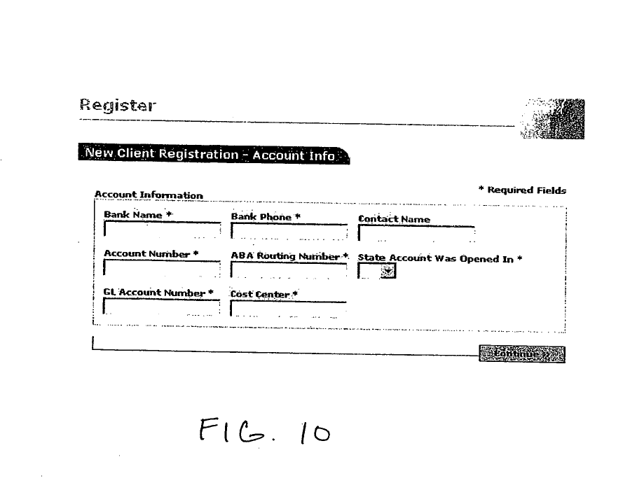

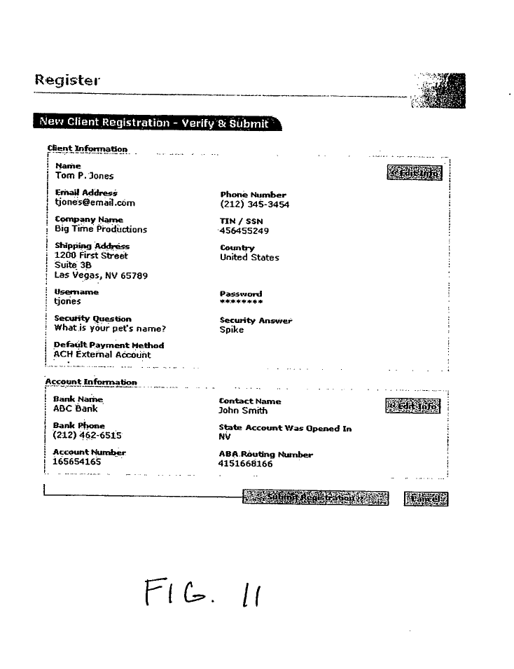

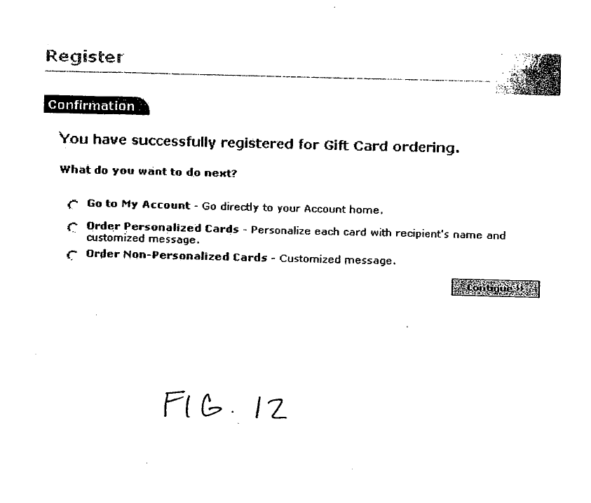

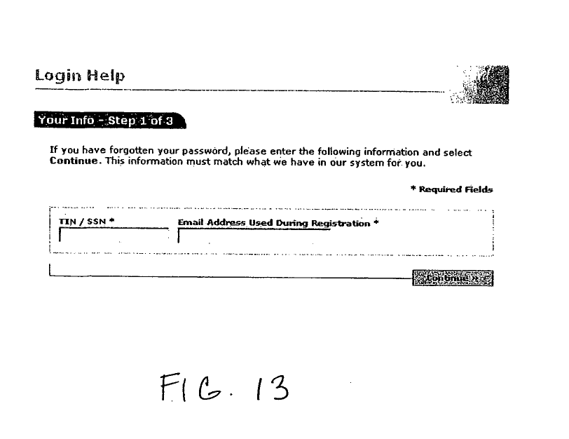

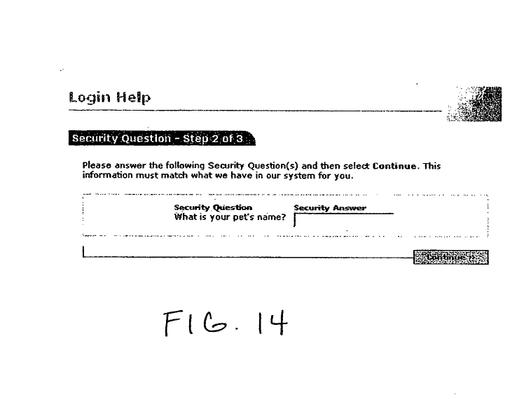

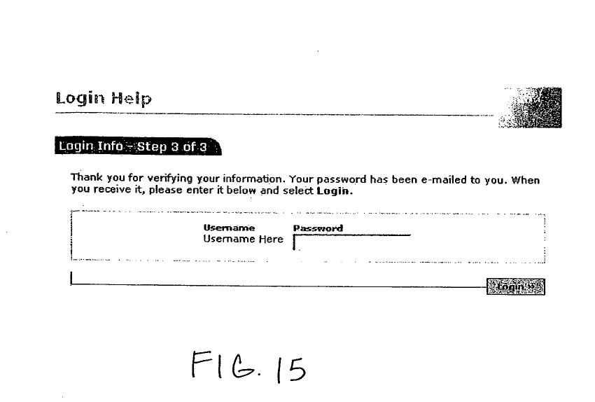

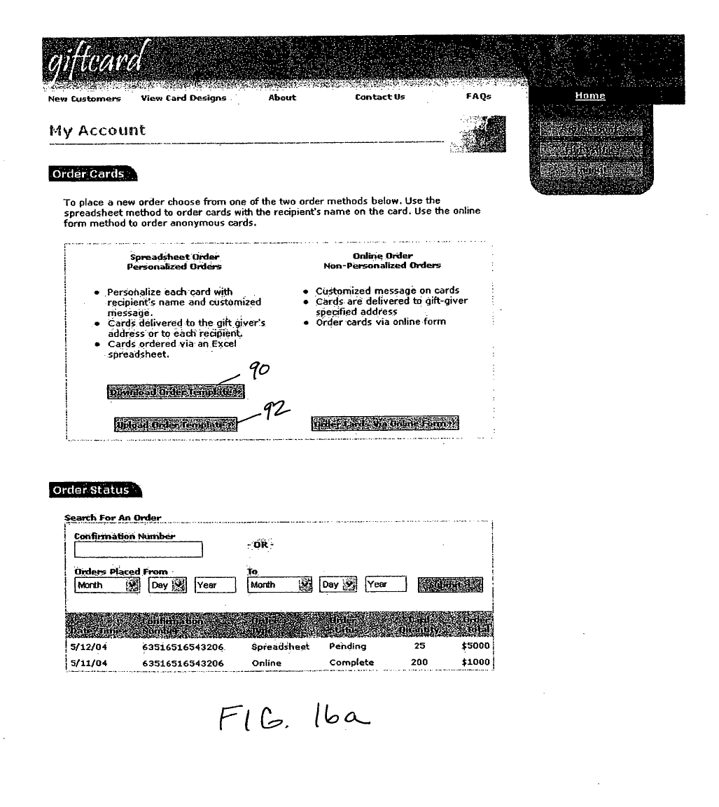

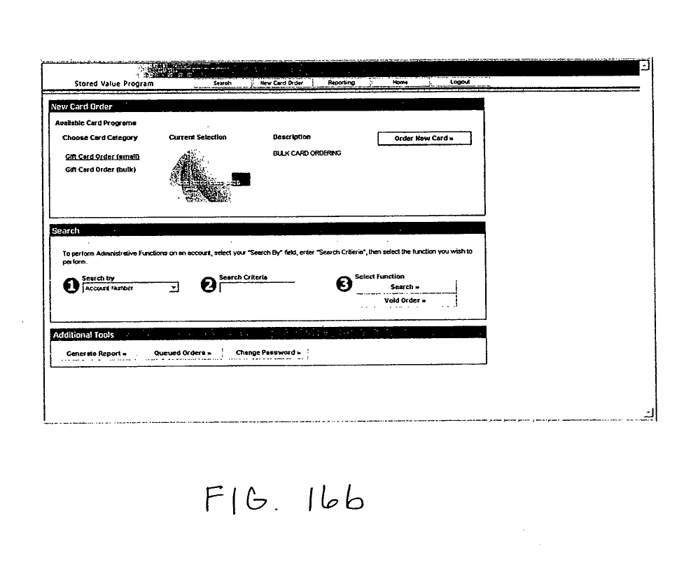

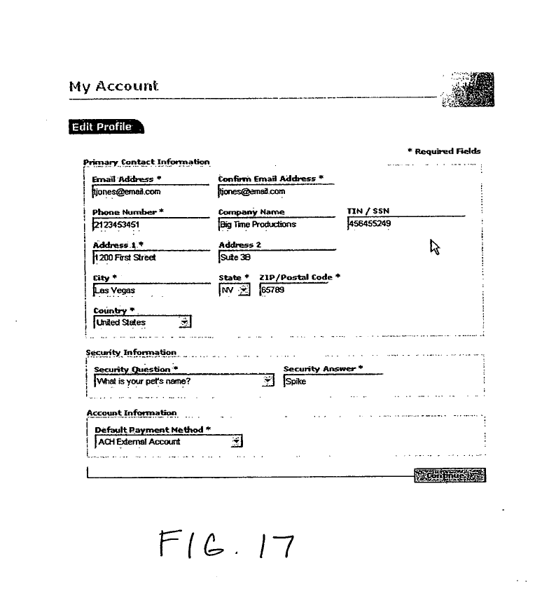

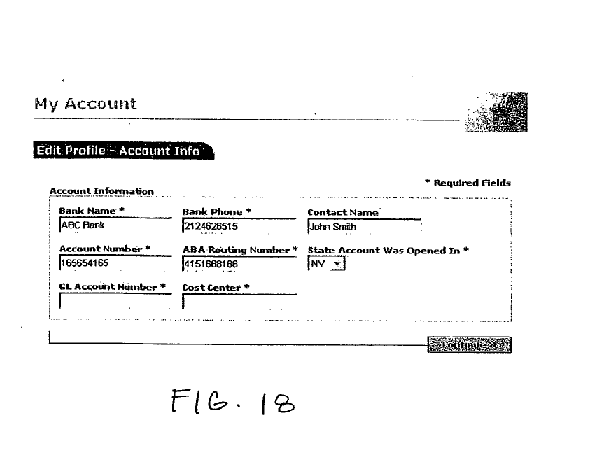

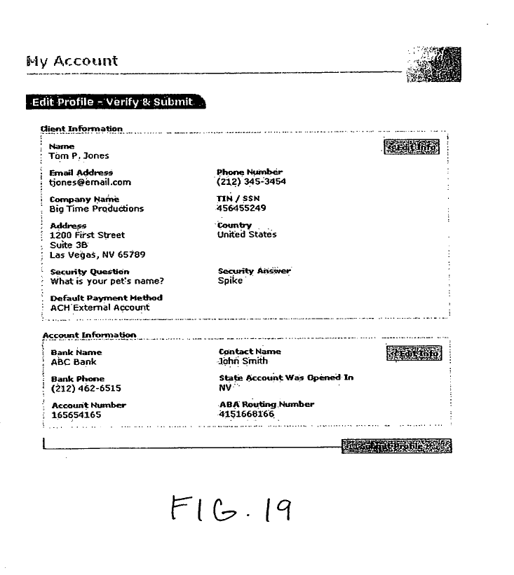

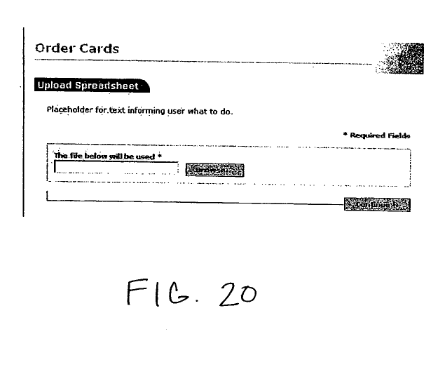

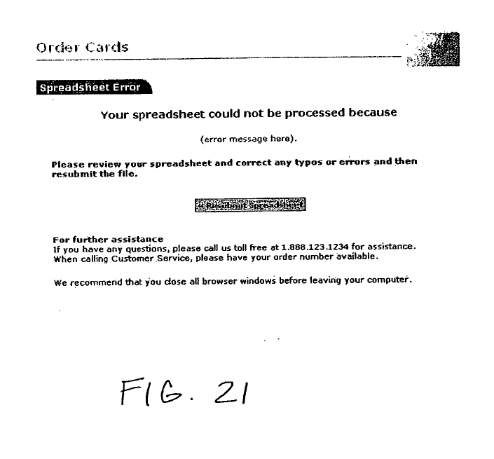

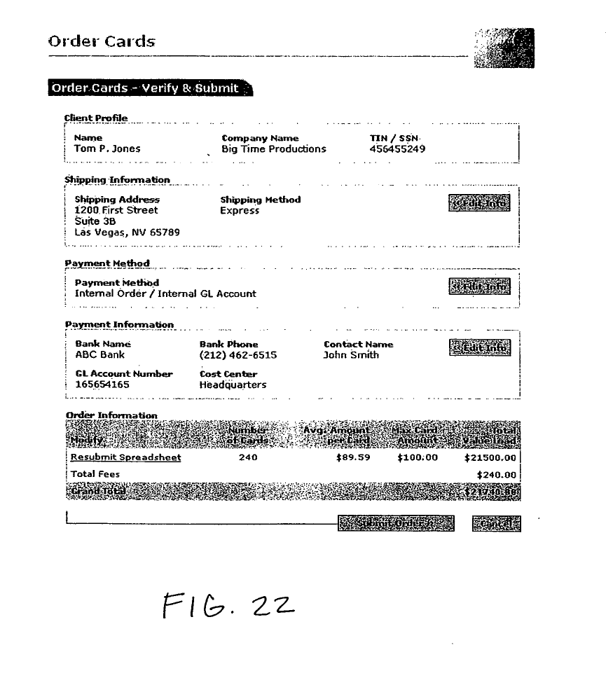

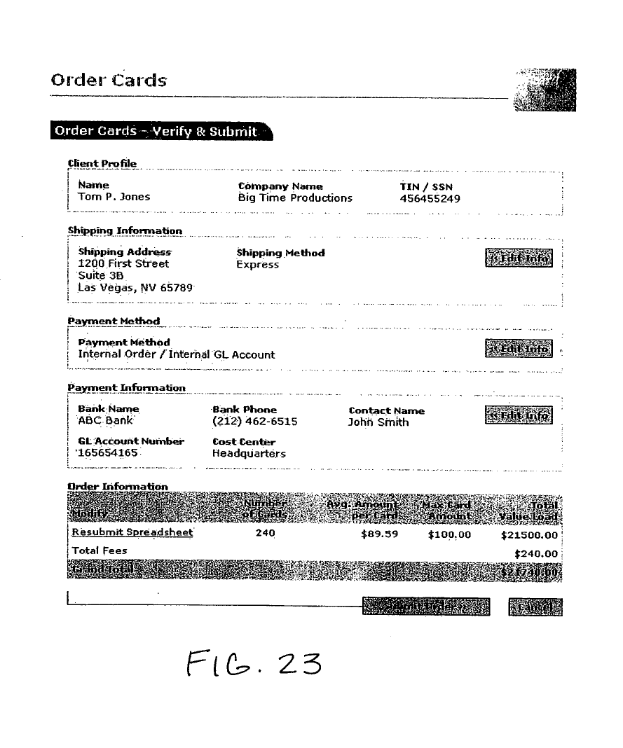

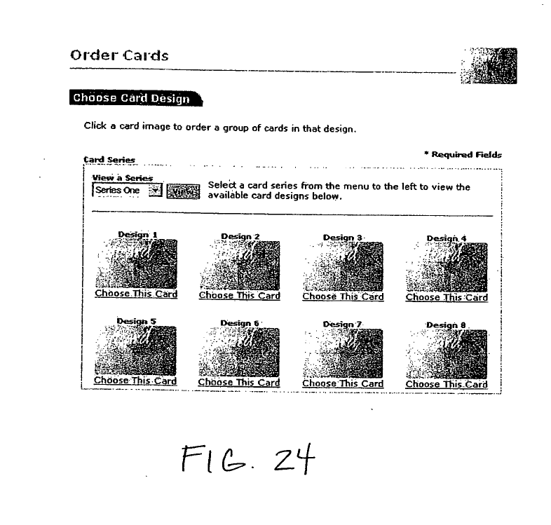

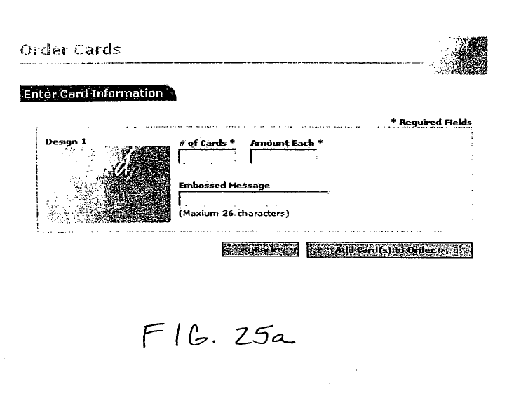

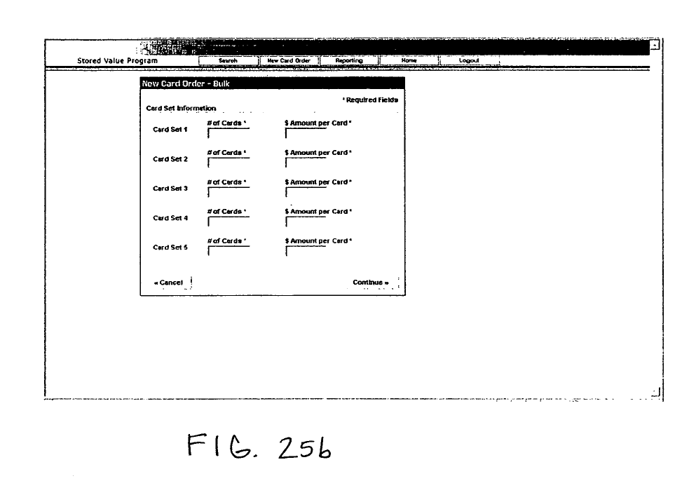

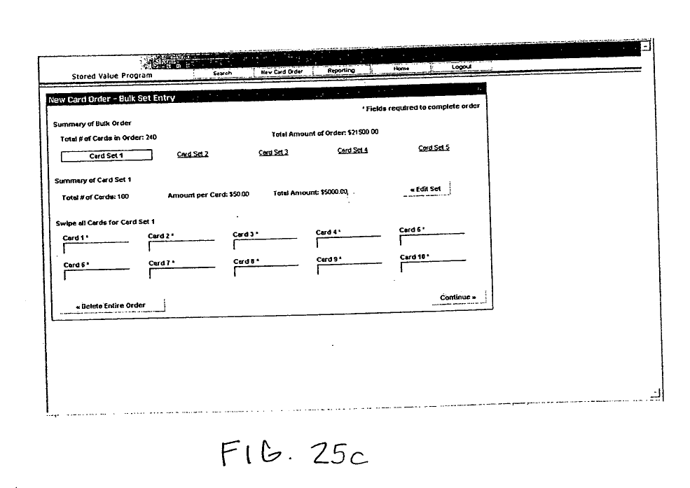

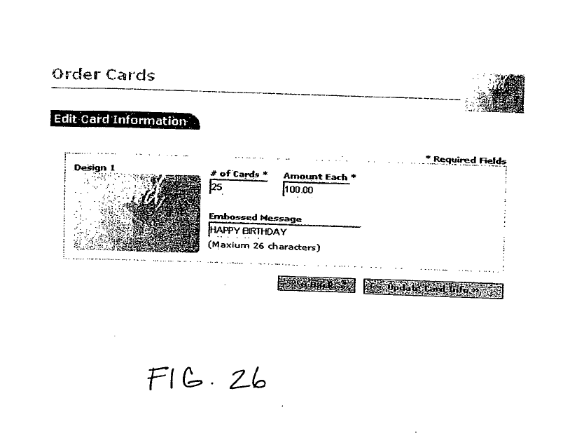

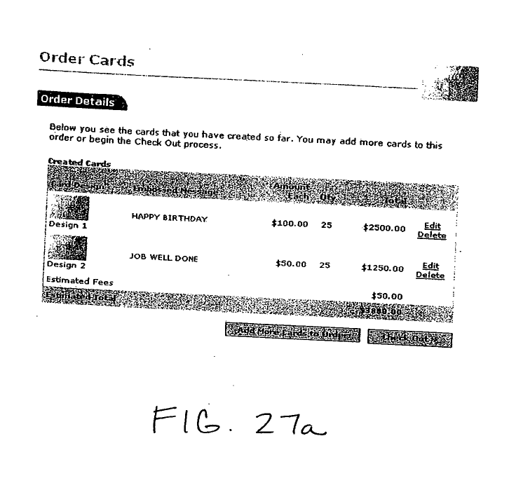

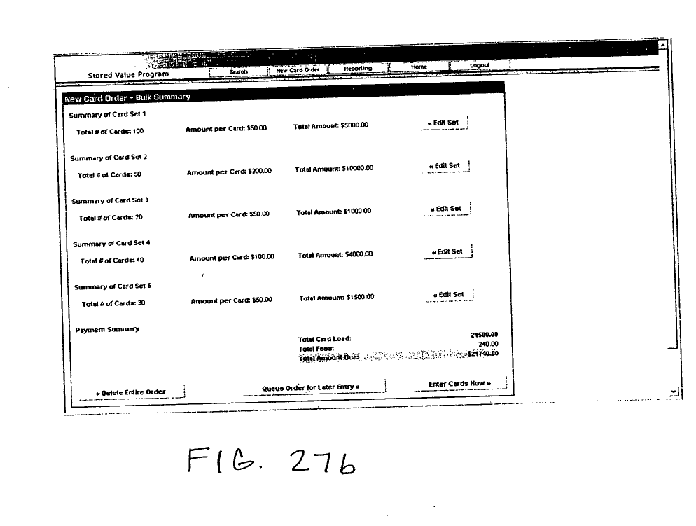

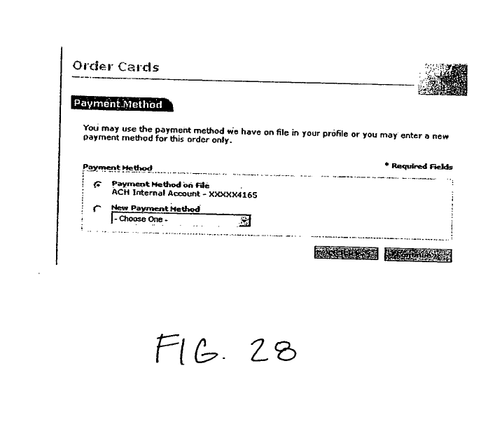

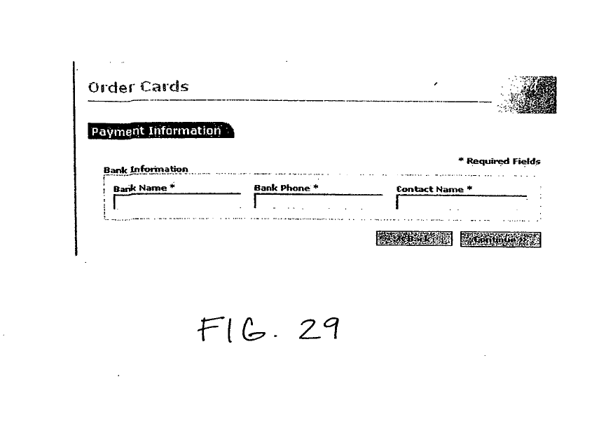

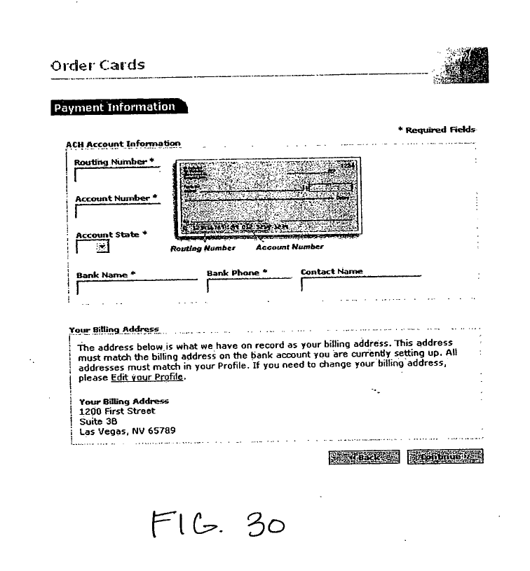

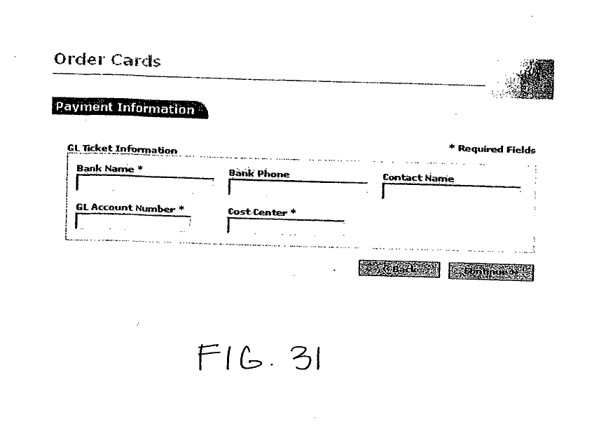

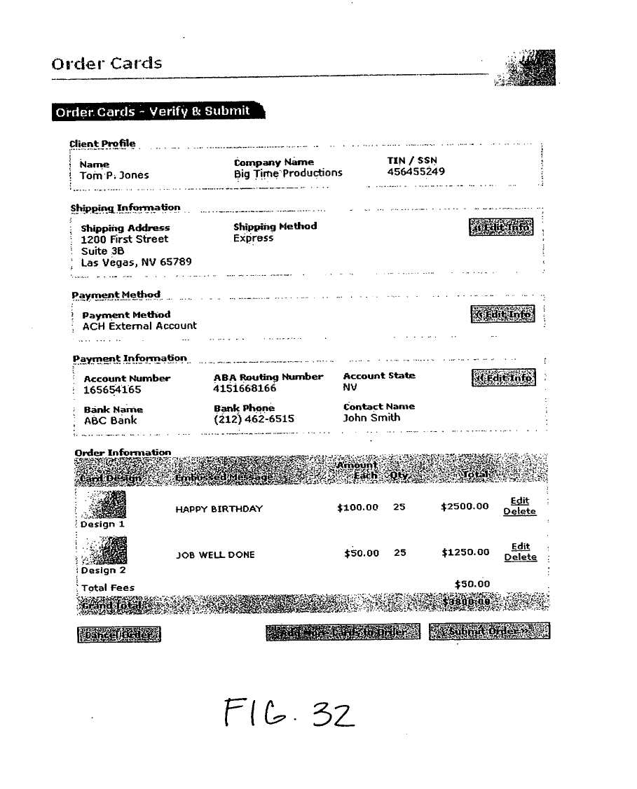

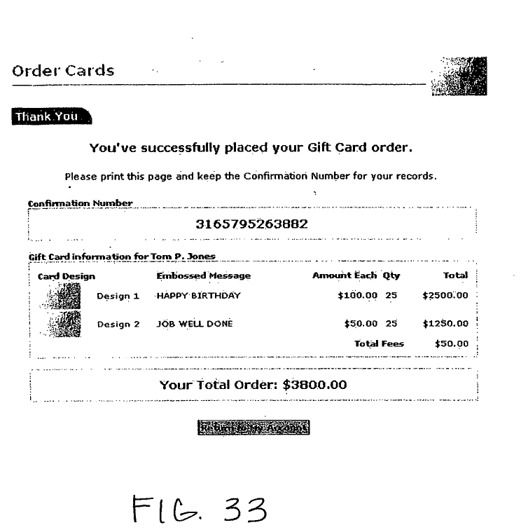

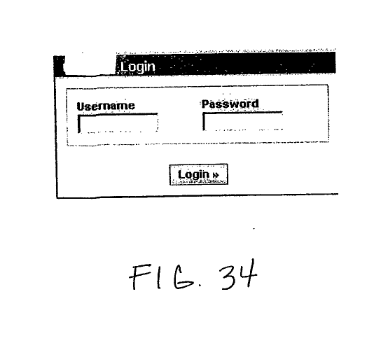

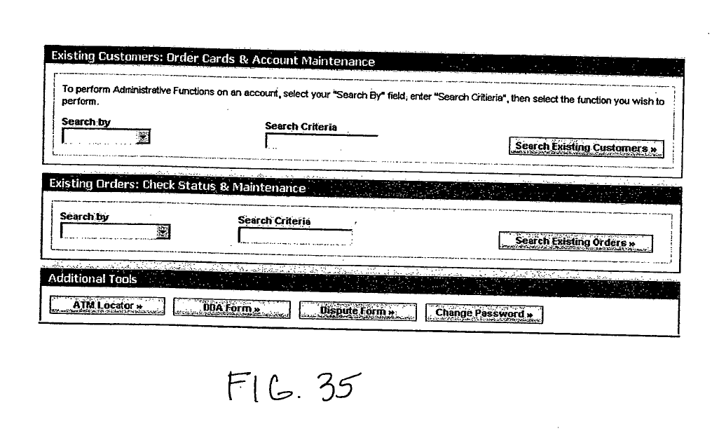

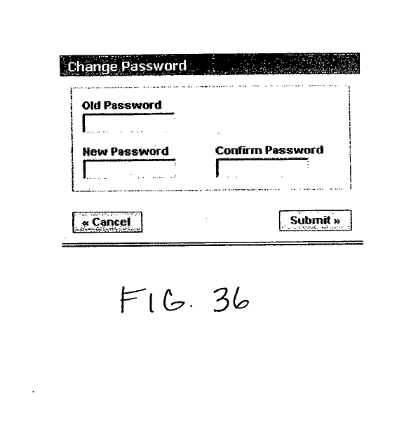

In some embodiments, the card processing system 52 can provide two types of systems or applications. For example, as shown in FIG. 2, the card processing system 52 can provide a consumer-based ordering website 80 that a consumer (e.g., a representative of a corporation or other organization) can access (e.g., with a general purpose browser application executed by the client computer 54) and use to self-register with the system 52, download order forms, place orders, upload order forms, and/or view order status and/or transaction history. FIGS. 3-36 illustrate various screens, pages, and forms displayed by the consumer-based ordering website 80 according to embodiments of the invention. A consumer can use the screens, pages, and forms shown in FIGS. 3-36 to register with the card processing system 52, log into the system 52, place an order, download an order form, upload an order form, view the status of an order, edit a profile of a registered consumer, etc. For example, using a home page or a “My Account” page provided by the consumer-based ordering website 80, as shown in FIG. 16a, a consumer can download an order form by selecting a download order form selection mechanism 90 and can upload an order form by selecting an upload order form selection mechanism 92. In some embodiments, selecting the upload order form selection mechanism 92 can display an upload order form page, as shown in FIG. 20. In addition, rather than uploading an order form using the upload order form page, as shown in FIG. 20, a consumer can directly place an order using order placement pages or forms directly provided by the consumer-based ordering website 80, as shown in FIGS. 24-33. As shown in FIGS. 25a and 25b, a consumer can order a single card, multiple cards, and/or multiple sets of cards within a single order.

As shown in FIG. 2, the card processing system 52 can also provide a business-to-business (“B2B”) ordering application 82 that clients of the card processing system 52 (e.g., individuals or organizations with pre-existing relationships with the card processing system 52), such as financial institutions, can use to place orders on behalf of a consumer; download and upload an order form on behalf of a consumer, perform approval steps to validate a consumer, a payment for an order, or an order (e.g., approve and submit an order for batch processing, decline or reject an order, edit an order, download, review, and edit a submitted order form, etc.), check the status of an order; etc. In some embodiments, all functions performed by a consumer using the consumer-based ordering website 80 can be performed by a client using the B2B ordering application 82 on behalf of the consumer.

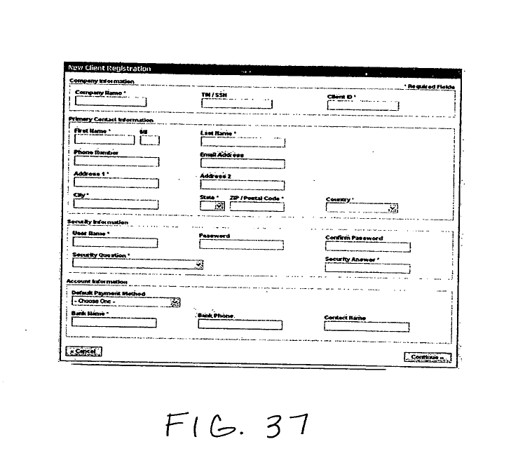

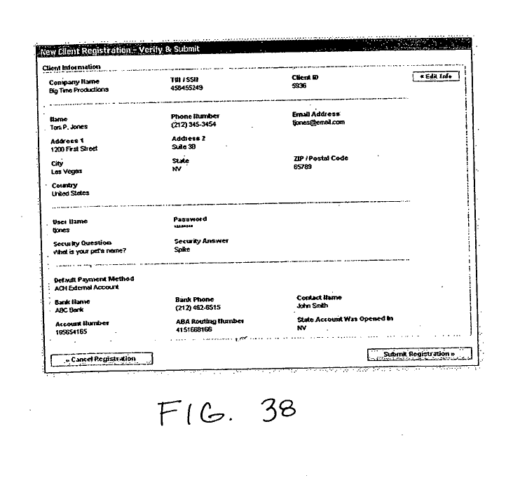

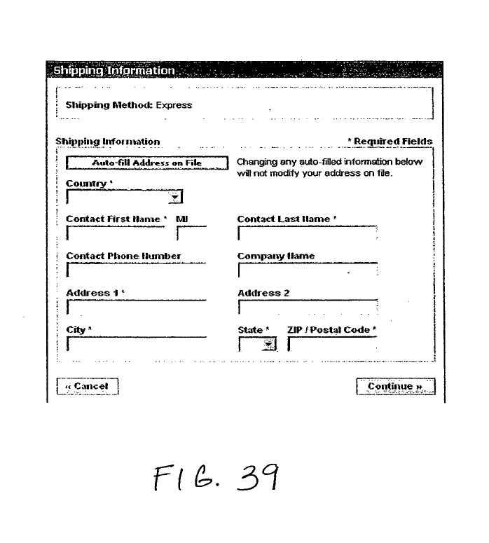

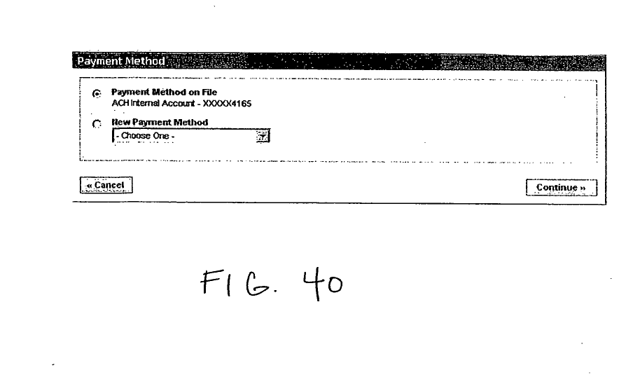

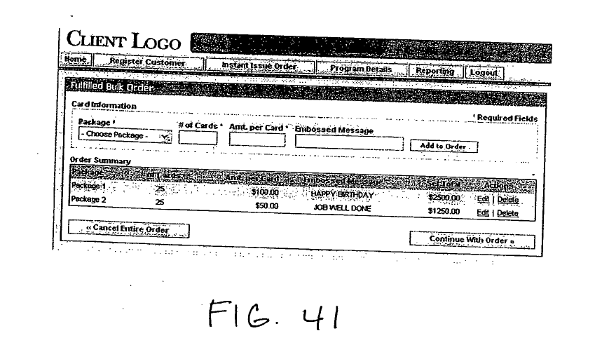

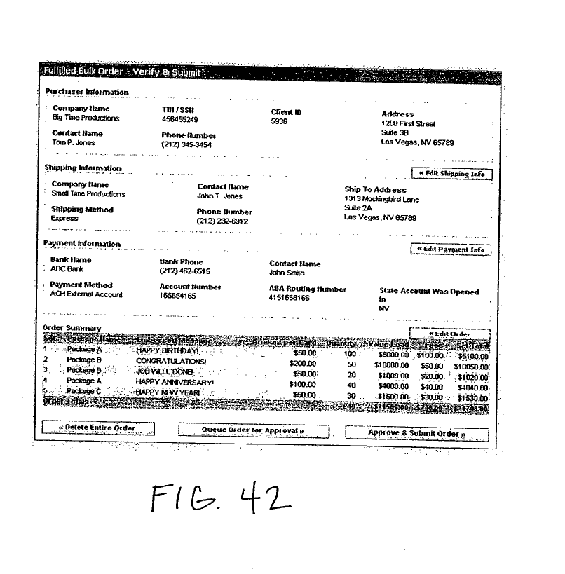

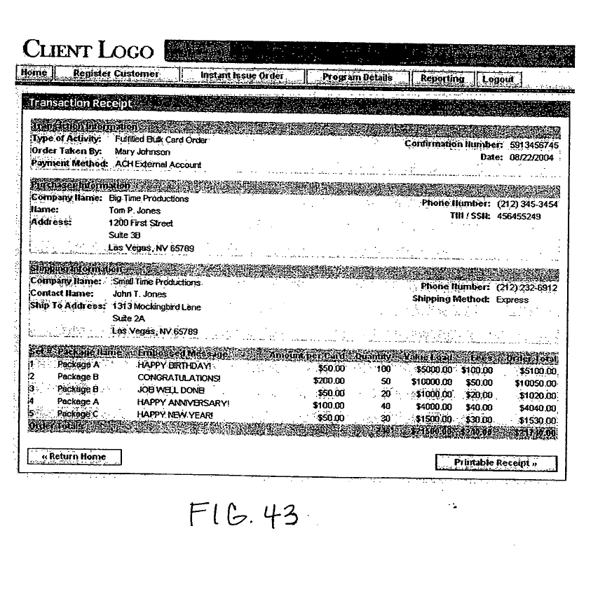

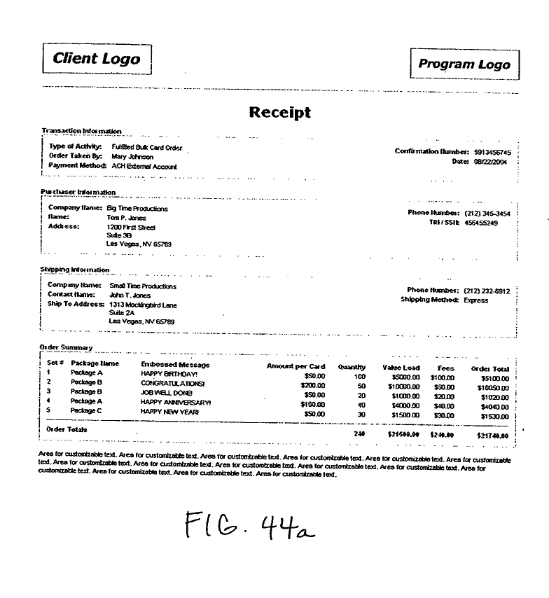

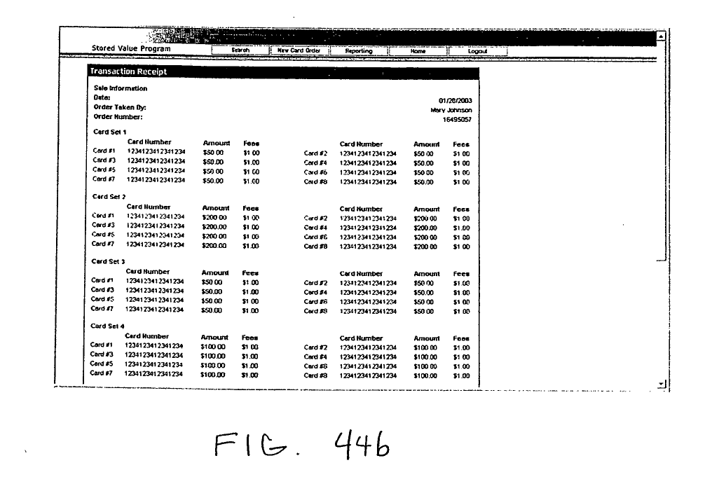

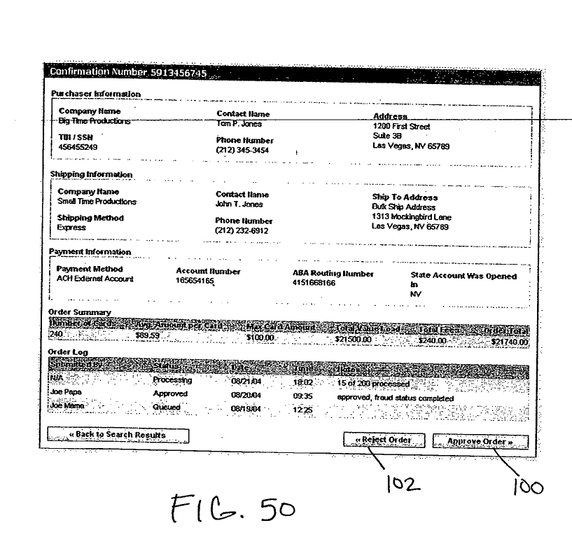

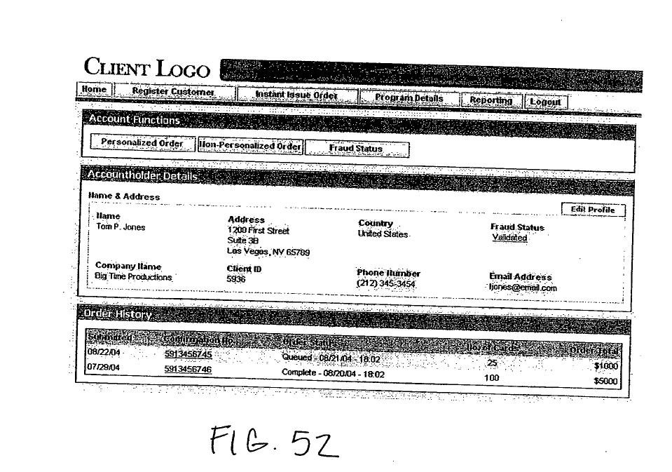

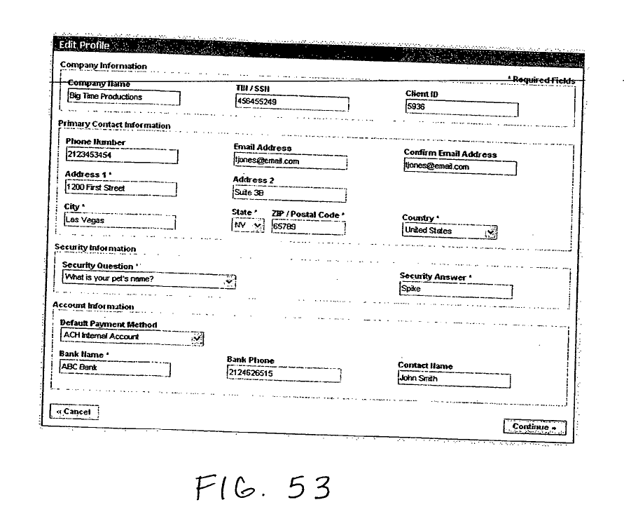

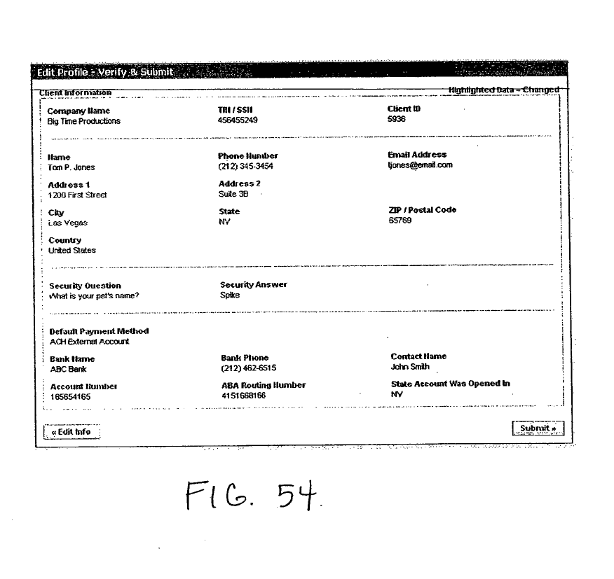

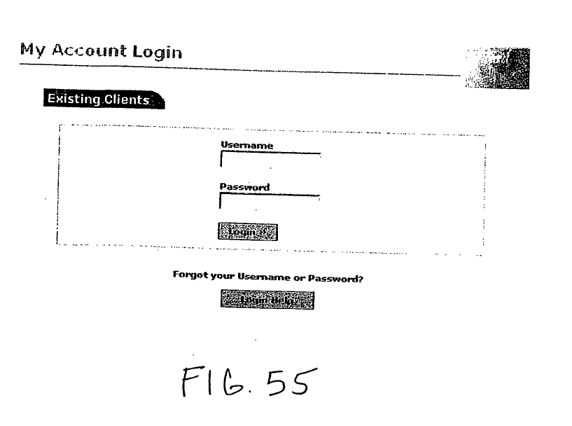

In some embodiments, the B2B ordering application 82 can also allow a client to download and/or view log files, download order forms or records that the card processing system 52 could not process, and/or resubmit corrected order forms, files, or records. In some embodiments, the B2B ordering application 82 can include an order placement module that is installed on and executed by or accessed by a client computer 54 operated by the client, which allows the client to interact with the B2B ordering application 82 and/or the card processing system 52. FIGS. 37-55 illustrate various screens, pages, and forms displayed by the B2B ordering application 82 according to embodiments of the invention. A client can use the screens, pages, and forms shown in FIGS. 37-55 to register with the card processing system 52, login to the card processing system 52, download an order form, upload an order form, place an order on behalf of a consumer, approve an order, reject an order, check on the status of an order, etc. For example, using an order form or “Spreadsheet Bulk Order” page, as shown in FIG. 45, a client can download an order form by selecting a “Download Template” selection mechanism 94. As shown in FIG. 45, a client can also upload an order form using an input mechanism 96 and/or a browse or search selection mechanism 98. As shown in FIGS. 39-44, a client can also use the B2B ordering application 82 to directly place an order using order placement pages or forms provided by the B2B ordering application 82.

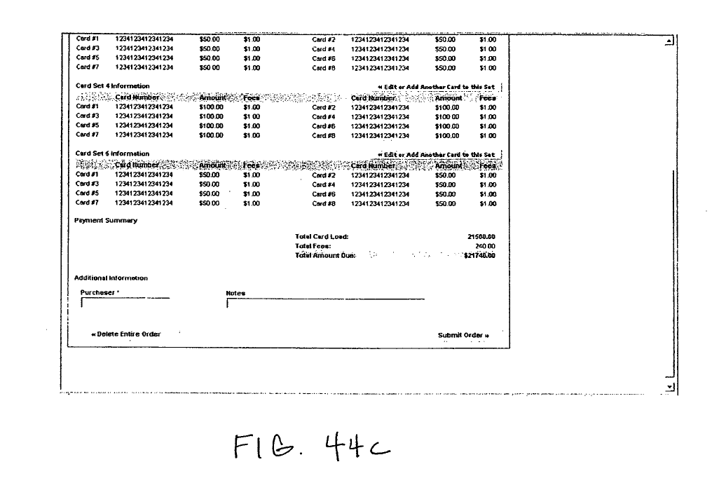

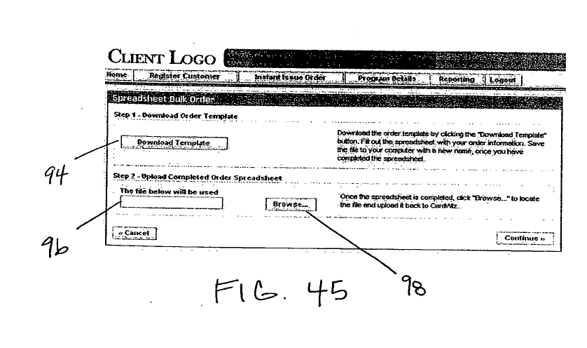

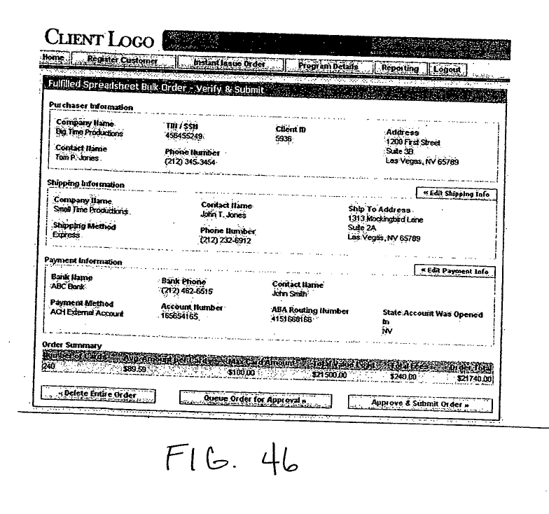

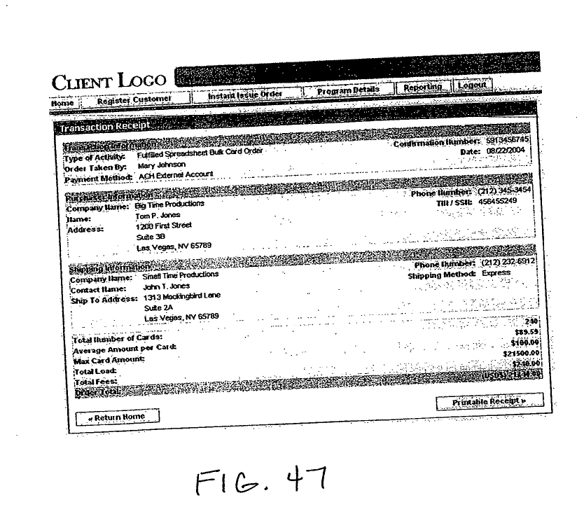

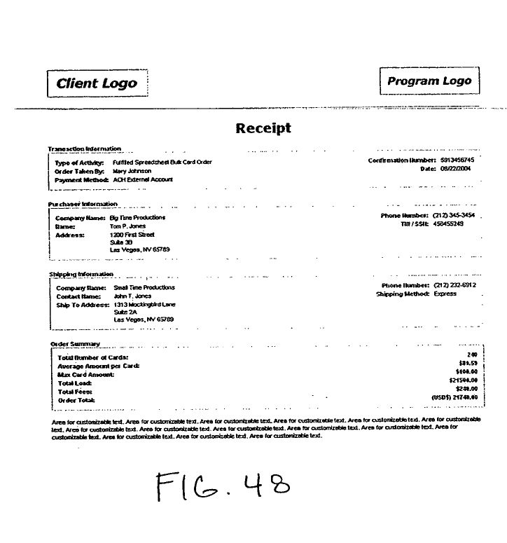

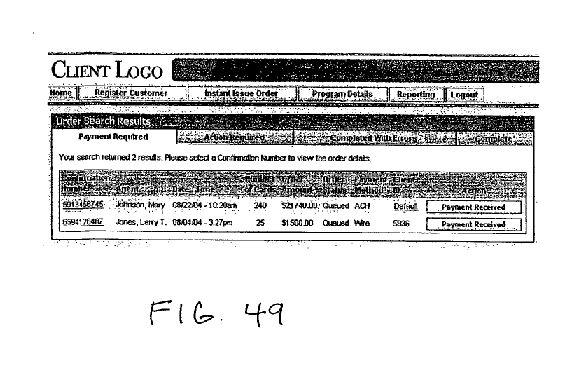

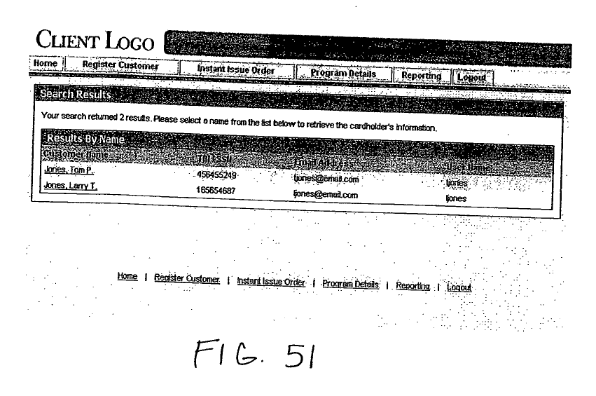

In some embodiments, as shown in FIGS. 44a, 44b, 44c, and 48, a client can also use the B2B ordering application 82 to obtain and/or print a receipt for an order. In addition, as noted above, a client can use the B2B ordering application 82 to approve an order by selecting an “Approve Order” selection mechanism 100, as shown in FIG. 50. A client can also reject an order by selecting a “Reject Order” selection mechanism 102. In some embodiments, a client can approve an order once payment for the order has been received. Orders approved or rejected by the client can include orders placed by the client on behalf of a consumer using the B2B ordering application 82 and/or orders placed by a consumer using the consumer-based ordering website 80.

As shown in FIGS. 25-26 and 41, in some embodiments, the consumer-based ordering website 80 and/or the B2B ordering application 82 can also allow users to load value (e.g., funds) to an ordered card.

FIG. 2 illustrates a process of ordering cards using the consumer-based ordering website 80 and the B2B ordering application 82 according to one embodiment of the invention. As shown in FIG. 2, the process includes a consumer (e.g., a payroll clerk or a human resources administrator) that desires to place an order for one or more cards. The consumer can initiate an order process by accessing the consumer-based ordering website 80. If the consumer has not previously registered with the system 52, the consumer registers with the system 52. If the consumer is a registered consumer, the consumer can log into the system 52 through the consumer-based ordering website 80 by providing identification and/or credentials, such as a previously-established username and password.

Once a consumer is registered or after a registered user is logged into the system 52, the consumer can download an order form, such as the order form 60 shown in FIGS. 1B and 1C. The consumer can complete the downloaded order form to order one or more personalized and/or non-personalized cards, as described above, and can upload the order form to the system 52 using the consumer-based ordering website 80. As noted above, the consumer can copy order information (e.g., recipient names) from other sources (e.g., databases, files, other order forms, etc.) into the downloaded order form.

In some embodiments, the order form and/or the system 52 (e.g., via the consumer-based ordering website 80) can validate uploaded order forms and can prompt the consumer to verify and submit uploaded order forms to the system 52. Validation performed by the order form 60 and/or the system 52 can include confirming that order information is consistent and adheres to the rules or guidelines of the system 52. For example, if an order has a shipping location selection of “Bulk,” the shipping method can be required to be “Express.” Other types of validation performed by the order form 60 and/or the system 52 can include verifying that specific order information includes valid selections or options (e.g., a shipping method must be either “Express” or “Standard,” a shipping location selection must be “Bulk ship to address on file,” “Bulk ship to new address,” or “Ship individually to recipients,” etc.). In some embodiments, the order form 60 and/or the system 52 can also verify that package selections include valid, active packages. For each valid and active package the system 52 can store a subprogram that includes a set of configuration elements that define a specific card product (card fees, card usage rules, card load rules, risk management configurations, etc.). The system 52 can use the subprogram to verify that an order for a specific card package adheres to the rules and guidelines of the package. For example, the order form 60 and/or the system 52 can verify that value loaded to a card is a numeric value and adheres to the load rules associated with the card package (e.g., a minimum amount, a maximum amount, etc.).

In some embodiments, the order form 60 and/or the system 52 also verifies a card recipient's name and address. For example, the order form 60 and/or the system 52 can verify that each component or field of a card recipient's name and/or address is less than a maximum number of characters allowed by the system 52 and that each required component or field is not null or blank. For card recipient addresses that include a U.S. or a Canadian address, the order form 60 and/or the system 52 can verify that the recipient's state is a valid two letter state code and that the recipient's zip code is in 5 digit or 9 digit format. In some embodiments, the order form 60 and/or the system 52 can also verify that a card recipient's country is a valid three digit International Organization for Standardization (“ISO”) country code (e.g., 840=U.S.).

If the order information includes a card recipient's email address, the order form 60 and/or the system 52 can verify that the email address is less than a maximum number of characters allowed by the system 52. In some embodiments, the order form 60 and/or the system 52 can also verify that a recipient's email address is a valid email address and, if an email address is required for a card recipient, that a card recipient's email address is not null or blank. Similarly, if the order information includes a card recipient's telephone number, the order form 60 and/or the system 52 can verify that recipient's telephone number is less than the maximum number of characters allowed by the system, is numeric, and, if required by the system 52, is not null or blank. In some embodiments, the order form 60 and/or the system 52 can also verify that a card recipient's social security number, if provided, is a valid 9-digit U.S. social security number. If the order form 60 and/or the system 52 determines that a card recipient's social security number is not valid, the order form 60 and/or the system 52 can change the recipient's social security number to null.

In some embodiments, the order form 60 and/or the system 52 can also validate an order using one or more fraud detection systems and/or identity authentication systems provided by various vendors and organizations. For example, the system 52 can use RiskWise and/or data and systems provided by the Office of Foreign Assets Control (“OFAC”) to screen orders for fraudulent activities. In some embodiments, if the card processing system 52 determines that an order includes one or more potentially fraudulent or high risk card orders (e.g., using a fraud detection system and/or an identity authentication system), the card processing system 52 can flag the order and/or particular line items included in the order. The flagged order and/or line items can then be manually or automatically reviewed by the system 52 and/or an external system in order to determine whether to accept or reject the order and/or the individual line items. In some embodiments, if one or more line items associated with an order are rejected, the entire order can be rejected. In other embodiments, individual line items of an order can be rejected and other line items associated with the same order can be approved. In some embodiments, if an order or a line item of an order is rejected, the card processing system 52 can scan or access internal and/or external data storage devices and/or systems (e.g., using a data scanning or management system, such as Octopus provided by Legato Systems, Inc.) in order to identify other cards with card or cardholder information that is similar to the rejected order or line item. If additional cards associated with the rejected order or line item are identified, the cards can be flagged for manual and/or automatic review by the system 52 and/or an external system. In some embodiments, the fraud detection and/or identity authentication process performed by the system 52 can be configured based on the type of card ordered, the amount of money loaded on a card, the consumer placing the order, etc.

It should be understood that the above validation processes can be performed by the order form 60, the consumer-based ordering website 80, the B2B ordering application 82, the card processing system 52, and/or a combination thereof.

As shown in FIG. 2, after the consumer submits the order to the system 52, the consumer can make a payment for the order to a financial institution or other payment processing organization or system. In some embodiments, the payment processing system can be included in the card processing system 52 and can be considered a client of the card processing system 52. When the payment processing system receives a payment from the consumer, the payment processing system can set the status of the order to “Payment Received” (e.g., using the B2B ordering application 82). In some embodiments, the payment processing system can automatically set the status of an order to “Payment Received” upon receiving the payment. In other embodiments, an individual associated with the payment processing system can manually set the status of an order to “Payment Received” using the B2B ordering application 82 once he or she is informed of a received payment.

After marking the payment as received, the payment processing system can approve the order (e.g., using the B2B ordering application 82). In some embodiments, the payment processing system can automatically approve an order upon receiving the payment for the order. In other embodiments, an individual associated with the payment processing system can manually approve an order using the B2B ordering application 82 (e.g., once he or she is informed of a received payment).

After the order has been approved, the card processing system 52 processes the order. In some embodiments, processing an order can include creating accounts associated with ordered cards and sending instructions to a card creation or embossing firm to create the ordered cards. In some embodiments, the card creation firm can be included in the card processing system 52. In other embodiments, the card creation firm can be an organization or system separate from the card processing system 52. Once the card creation firm creates the cards, the cards are shipped as requested by the consumer. In some embodiments, the card creation firm ships the cards as requested by the consumer. In other embodiments, the card creation firm returns the created cards to the card processing system 52, which then ships to the cards as requested by the consumer. As shown in FIG. 2, the cards (e.g., personalized cards) can be individually shipped to the card holders or recipients or the cards can be shipped in one or more bulk shipments to one or more senders. A sender can include the consumer who placed the order or a third-party individual or organization that is going to provide the created cards to cardholders.

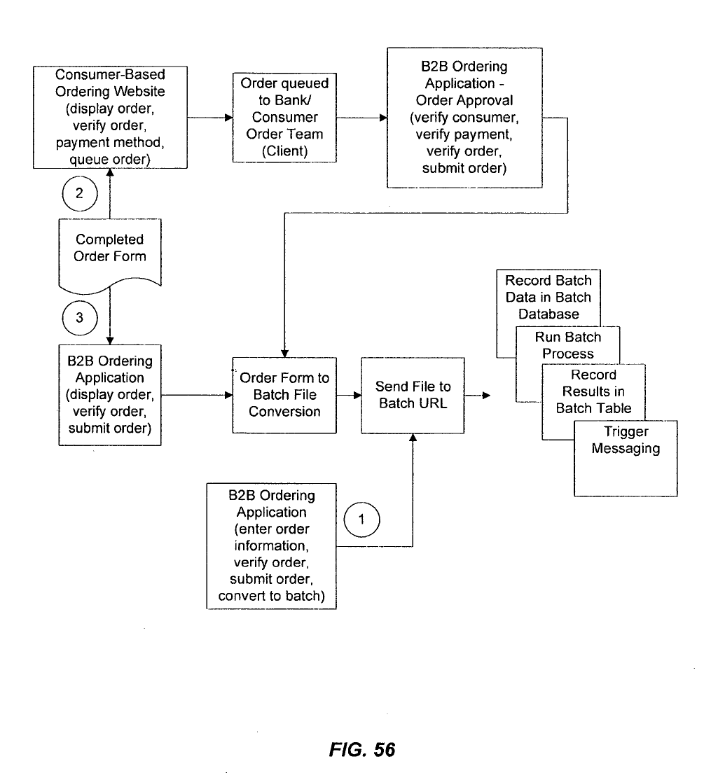

As noted above, the card processing system 52 can provide multiple ways for a consumer and/or a client to place an order. FIG. 56 illustrates a process for ordering cards using the card processing system 52 including three possible ordering scenarios. As shown in FIG. 56, in a first scenario, a client enters order information through the B2B ordering application 82 (e.g., on behalf of a consumer). The client approves the order and submits the order for batch processing. The card processing system 52 (e.g., a front end of the card processing system 52) converts the order to batch specifications in order to create a batch file and sends the batch file to a batch application or system (e.g., included in the card processing system 52). In some embodiments, the card processing system 52 sends the order to the batch system by sending the batch file to a batch uniform resource locator (“URL”) associated with the batch system. The batch system logs and processes the batch file. Upon completion, the batch system logs the completed processing, which can trigger outbound messaging to one or more sources.

In some embodiments, when the batch system logs the completed processing, a message, such as an email message, can be sent to the client and/or the consumer associated with the completed order. The message can include an order identifier or number, a message or text string stating that the order is complete, an indication of errors found (e.g., “yes,” errors found or “no,” errors not found), a number of cards created, a total amount loaded, a number of failed card create attempts, and/or an amount not loaded. In some embodiments, a similar message can be sent to the client and/or the consumer when an order is submitted to the system 52.

As shown in FIG. 56, in a second scenario, a consumer can download an order form, as described above with respect to FIGS. 1B and 1C, from the consumer-based ordering website 80. The consumer can enter order information into the downloaded order form and can submit the completed order form to the system 52 (e.g., via the consumer-based ordering website 80) for approval by a client (e.g., a payment processing system that receives a payment from the consumer). In some embodiments, the client can view and/or download a submitted order form through the B2B ordering application 82. The client can make changes to the order form as needed and, in some embodiments, can contact the consumer who placed the order if needed. The client can then upload an updated order form (if changes were made) and/or can approve the order for processing.

After the client approves an uploaded order form, the card processing system 52 can validate the data included the uploaded order form and can covert the order form data to batch specifications of the card processing system 52 in order to create a batch file. The card processing system 52 can then send the batch file to the batch system. The batch system logs and processes the batch file. Upon completion, the batch system logs the completed processing, which can trigger outbound messaging.

In a third scenario, as shown in FIG. 56, a client enters order information into a downloaded order form and uploads the order form for processing through the B2B ordering application 82. In some embodiments, the client can download and upload an order form using the B2B ordering application 82 in order to place an order on behalf of a consumer. The client approves the order for batch processing (e.g., using the B2B ordering application 82) and the card processing system 52 validates the data in the uploaded order form. The card processing system 52 then converts the order form to batch specifications of the card processing system 52 in order to create a batch file. The card processing system 52 sends the batch file to the batch system, and the batch system logs and process the batch file. Upon completion, the batch system logs the completed processing, which can trigger outbound messaging.

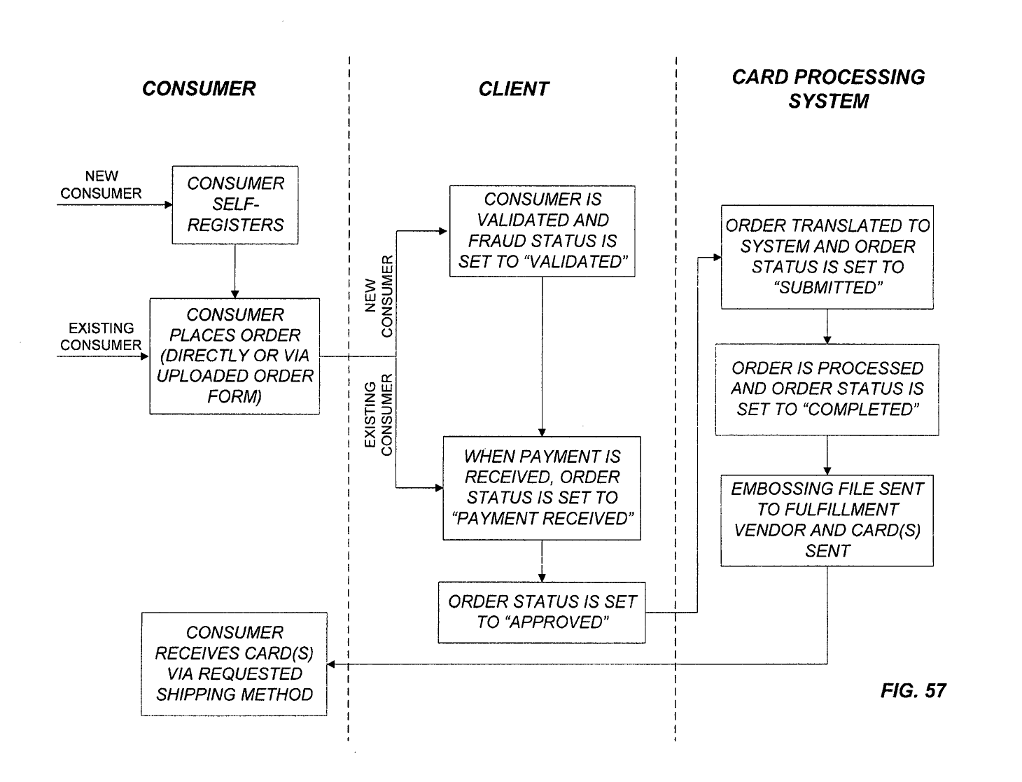

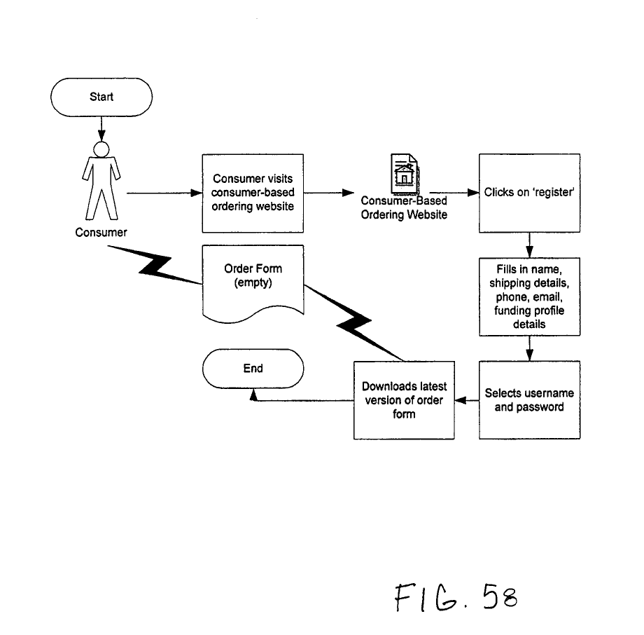

FIG. 57 illustrates additional details of ordering cards using the consumer-based ordering website according to one embodiment of the invention. As shown in FIG. 57, a new consumer can self-register with the system 52 using the consumer-based ordering website 80. In some embodiments, by allowing a consumer to register with the system 52, the consumer can place subsequent orders with the system 52 without having to re-enter or re-submit some information to the system 52, such as the consumer's name, address, preferred payment method, etc. After a new consumer registers, the consumer can place an order for one or more personalized and/or non-personalized cards using an order form downloaded from the consumer-based ordering website, as described above with respect to FIGS. 1B and 1C. FIG. 58 illustrates further details of the process of registering with the system 52 and downloading an order form using the consumer-based ordering website according to one embodiment of the invention. As previously noted, in some embodiments, the consumer-based ordering website 80 can also provide one or more order placement forms or pages that a consumer can use to directly place an order.

As shown in FIG. 57, after placing the order, a client and/or the card processing system 52 can validate the consumer and can set a fraud status associated with the consumer (e.g., using the B2B ordering application 82). For example, if the client and/or the card processing system 52 validates the consumer, the consumer's fraud status can be set to “Validated.” In some embodiments, the card processing system 52 can provide one or more fraud detection or fighting tools, such as eRacer, Riskwise, etc., that the client and or the system 52 can use to associate a fraud status with a particular consumer. In some embodiments, the client and/or the card processing system 52 only validates new consumers and allows existing, registered consumers to bypass the validation process. In other embodiments, the client and/or the card processing system 52 validates existing, registered consumers on a predetermined or random schedule.

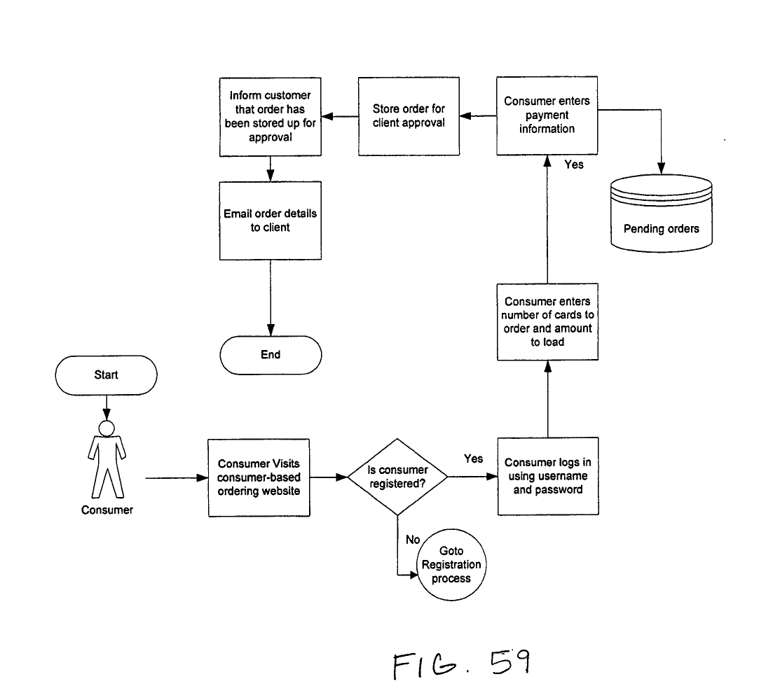

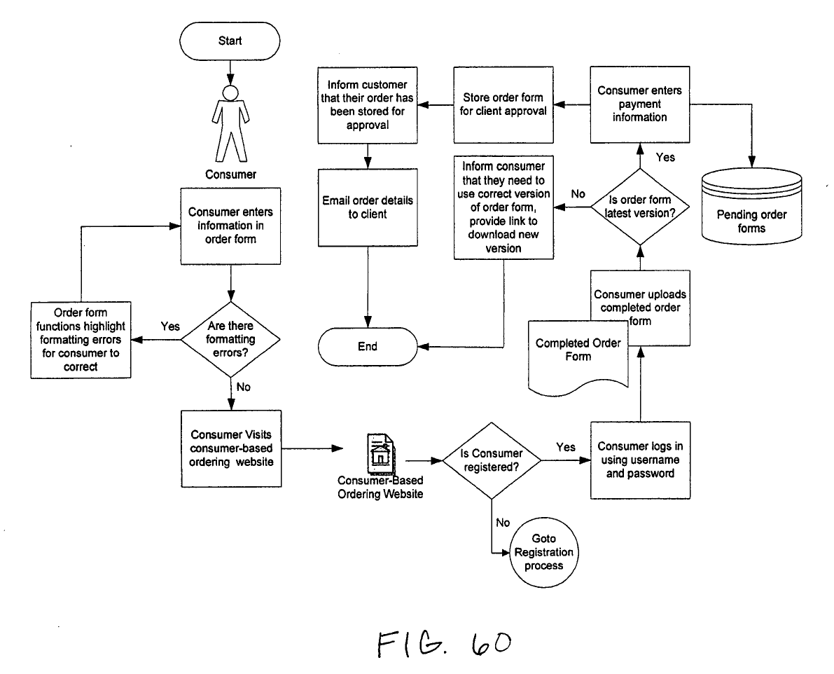

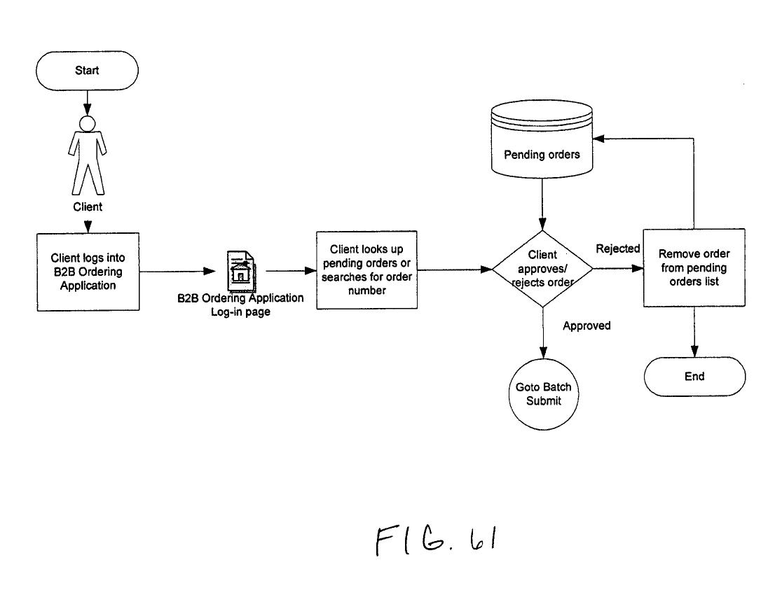

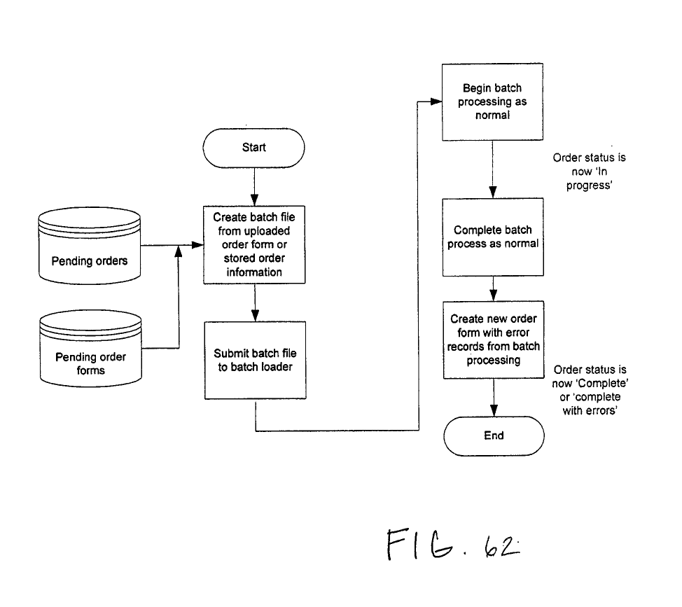

If a consumer has already registered with the system 52 (i.e., the consumer is an existing consumer), the consumer can place an order for one or more personalized and/or non-personalized cards using the downloadable order form accessible through the consumer-based ordering website 80 or using the order placement forms or pages directly provided by the consumer-based ordering website 80. FIGS. 59 and 60 illustrate further details of the process of placing an order using the consumer-based ordering website 80 using the downloadable order form or the order placement forms or pages directly provided by the website 80 according to one embodiment of the invention.

After a new consumer places an order and is validated by a client or the system 52 or after an existing consumer places an order, a client and/or the system 52 can monitor the order (e.g., using the B2B ordering application 82) in order determine when payment has been received from the consumer for the order. In some embodiments, the system 52 can automatically set the status of an order to “Payment Received” when a payment is received for the order (e.g., received directly by the system 52 or received by a third-party payment processing system). In other embodiments, a client associated with the system 52 or a third-party payment processing system can be notified of a received payment and can manually set the status of the order to “Payment Received” (e.g., via the B2B ordering application 82). For example, the client can be associated with a third-party payment processing system, such as a financial institution, and can set the status of an order to “Payment Received” once the payment processing system receives a payment for the order. As previously noted, in some embodiments, a third-party payment processing system can mange payments on behalf of the card processing system 52.

After the status of an order is set to “Payment Received,” the client and/or the card processing system 52 can set the status of the order to “Approved.” In some embodiments, a client can manually approve an order using the B2B ordering application 82. For example, as noted above, the client can be associated with a financial institution or payment processing system that receives a payment for an order. Once the financial institution or payment processing system receives a payment for an order, the client can manually approve the order using the B2B ordering application 82. In other embodiments, the system 52 can automatically approve an order once the system 52 receives a payment for an order or receives notification of payment received for an order. FIG. 61 illustrates further details of the process of approving an order according to one embodiment of the invention.

After an order is approved, the order is translated to the card processing system 52 and the card processing system 52 sets the order status to “Submitted.” Next, the card processing system 52 processes the order status and sets the status of the order to “Complete.” In some embodiments, if the card processing system 52 encounters errors while processing an order, the card processing system 52 can set the status of the order to “Complete with errors” and/or can log and/or record one or more errors associated with the order. FIG. 62 illustrates further details of the order processing process performed by the card processing system 52 according to one embodiment of the invention.

After the order is processed, the card processing system 52 creates a file or instructions (e.g., an embossing file) and sends the file or instructions to a card creation or fulfillment vendor. The fulfillment vendor creates the cards and ships the cards to the consumer who the placed order, a cardholder associated with each ordered card, or a third-party recipient based on the shipping method set by the consumer when the consumer placed the order. In some embodiments, the fulfillment vendor can return created cards to the card processing system 52, and the card processing system 52 can ship the cards as requested by the consumer.

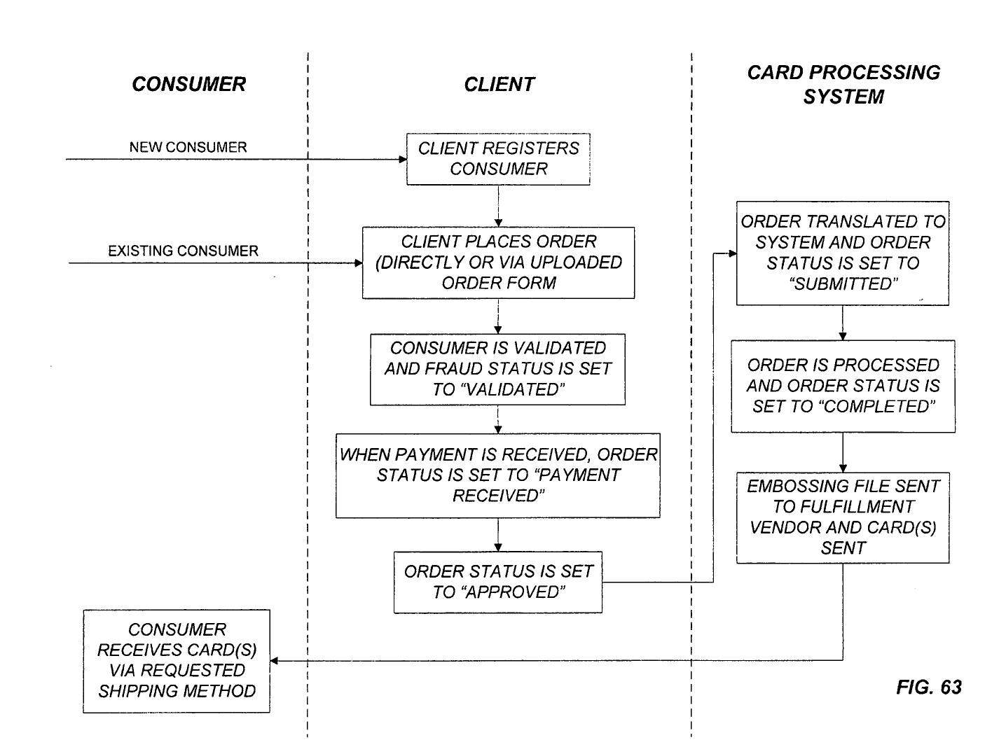

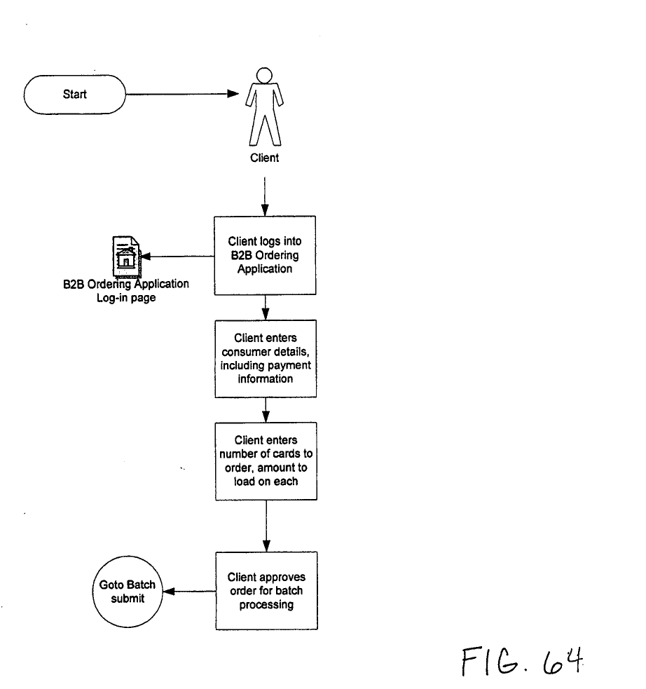

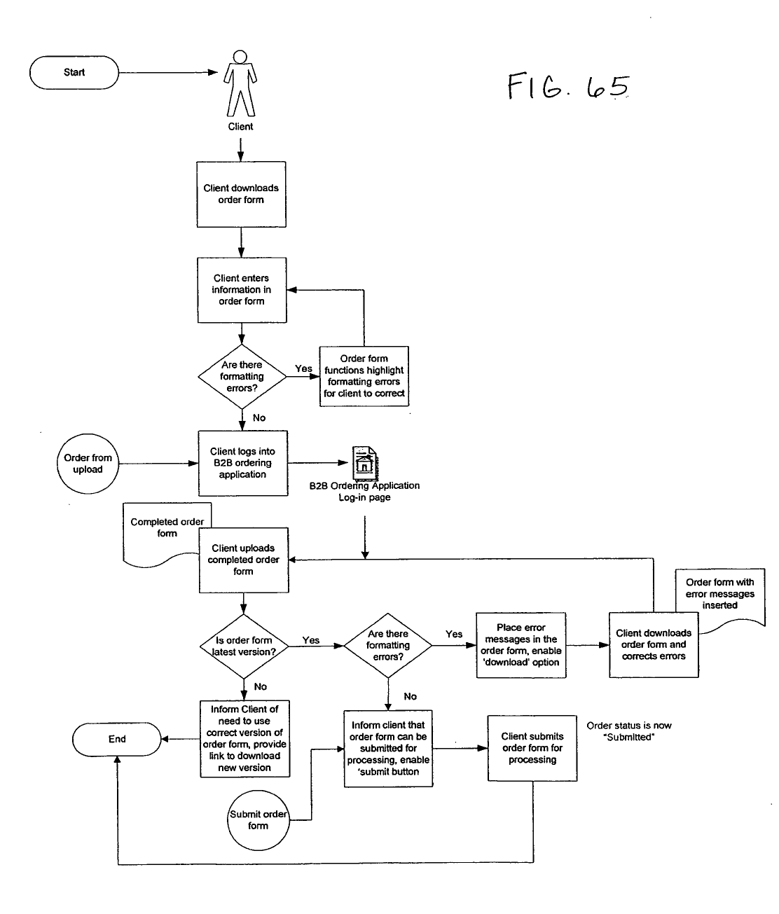

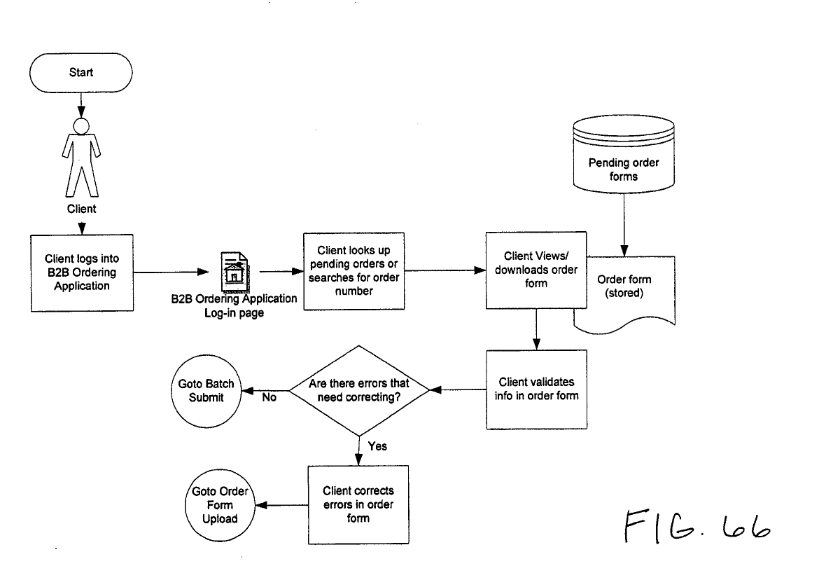

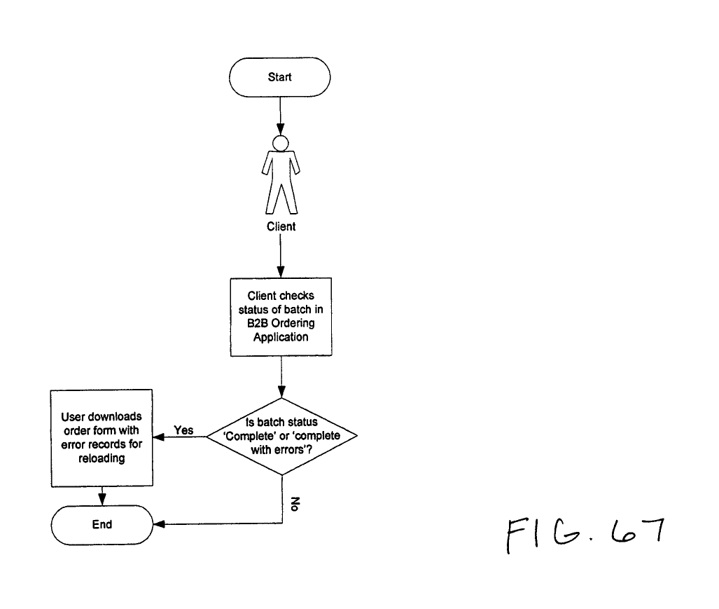

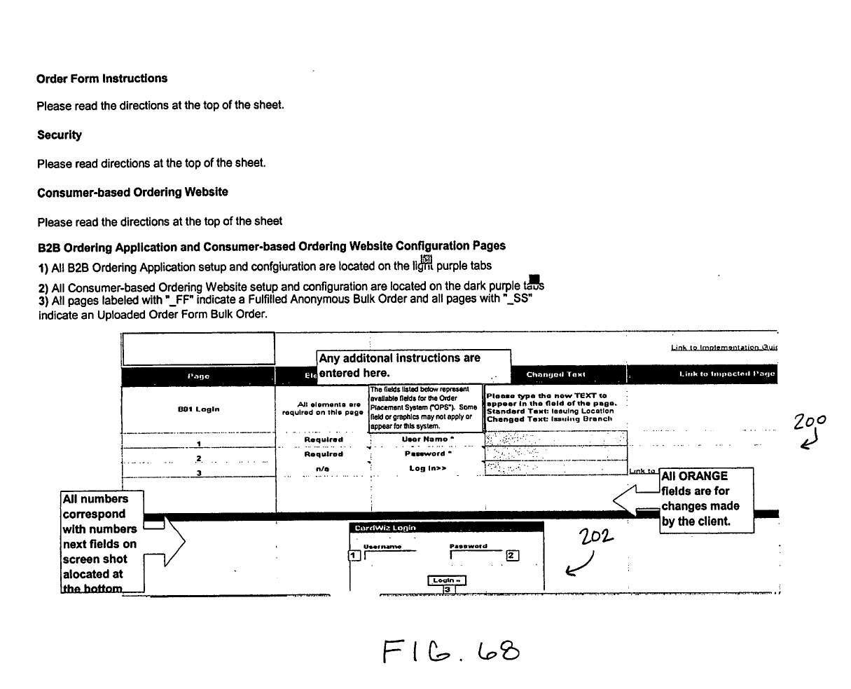

FIG. 63 illustrates additional details of ordering cards using the B2B ordering application 82. As shown in FIG. 63, a client can register a new consumer using the B2B ordering application 82. After a client registers a new consumer or if a consumer is a registered consumer, the client can place an order on behalf of the consumer for one or more personalized and/or non-personalized cards using an order form downloaded from B2B ordering application 82, as described above with respect to FIGS. 1B and 1C. As previously noted, in some embodiments, the B2B ordering application 82 can also provide one or more order placement forms or pages that a client can use to directly place an order on behalf of a consumer. FIGS. 64 and 65 illustrate further details of the process of placing an order using the B2B ordering application 82 using the downloadable order form or using order placement forms or pages directly provided by the application 82 according to one embodiment of the invention.

As shown in FIG. 63, after placing the order, a client and/or the card processing system 52 can validate the consumer and can set a fraud status associated with the consumer (e.g., using the B2B ordering application 82). For example, if the client and/or the card processing system 52 validates the consumer, the client and/or the card processing system 52 can set the consumer's fraud status to “Validated.” In some embodiments, as previously noted, the client and/or the card processing system 52 only validates new consumers.

Next, a client and/or the system 52 can monitor the order (e.g., using the B2B ordering application 82) in order determine when a payment has been received from the consumer for the order. In some embodiments, the system 52 can automatically set the status of an order to “Payment Received” when a payment is received for the order (e.g., received directly by the system 52 or received by a third-party payment processing system). In other embodiments, a client associated with the system 52 or with a third-party payment processing system can be notified of a received payment and can manually set the status of the order to “Payment Received” (e.g., via the B2B ordering application 82).

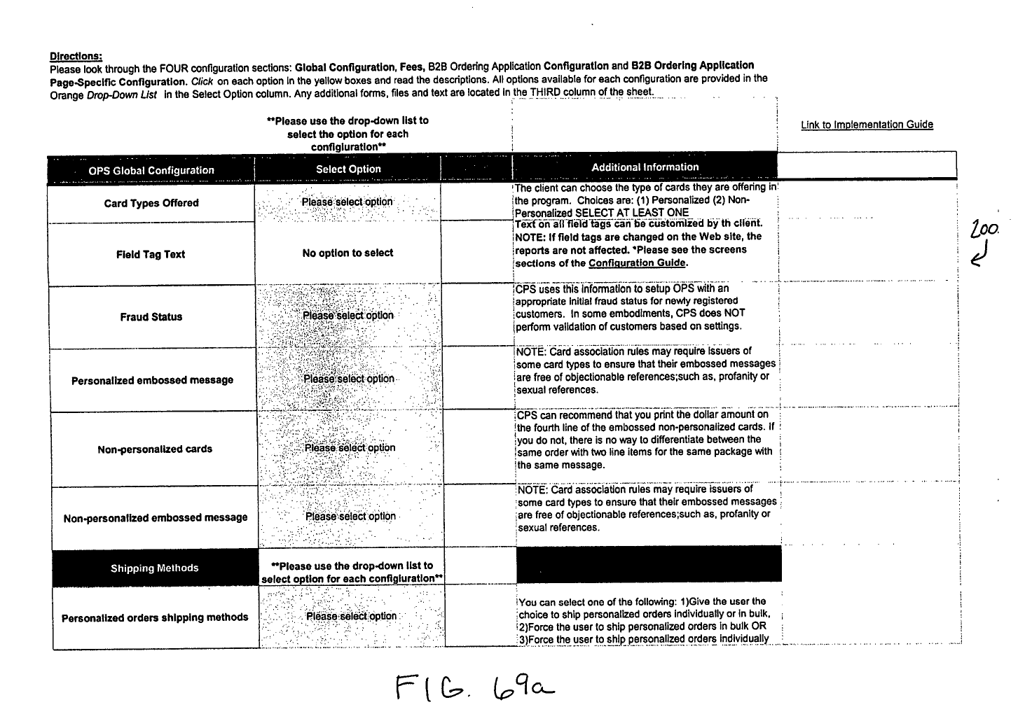

After the status of an order is set to “Payment Received,” the client and/or the card processing system 52 can set the status of the order to “Approved.” In some embodiments, a client can manually approve an order using the B2B ordering application 82. For example, as noted above, the client can be associated with a financial institution or payment processing system that receives a payment for an order. Once the financial institution or payment processing system receives a payment for an order, the client can manually approve the order using the B2B ordering application 82. In other embodiments, the system 52 can automatically approve an order once the system 52 receives a payment for an order or receives notification of a payment received for an order. In some embodiments, if an order form was uploaded by the client on behalf of a consumer, the client can use the B2B ordering application 82 to download the uploaded order form, review the order form, and edit the order form as needed. If the client updates or edits the order form, the client can re-upload the updated order form. FIG. 66 illustrates further details of the process of approving an order using the B2B ordering application 82 according to one embodiment of the invention.

After the order is approved, the order is translated to the card processing system 52 and the card processing system 52 sets the status of the order to “Submitted.” Next, the card processing system 52 processes the order and sets the status of the order to “Complete.” In some embodiments, if the card processing system 52 encounters errors while processing an order, the card processing system 52 can set the status of the order to “Complete with errors” and/or can log and/or records the one or more errors associated with the order. As noted above, FIG. 62 illustrates further details of the order processing process according to one embodiment of the invention.

After the order is processed, the card processing system 52 creates a file or instructions (e.g., an embossing file) and sends the file or the instruction to a card creation or fulfillment vendor. The fulfillment vendor creates the cards and ships the cards to the consumer who placed the order, to a cardholder associated with each ordered card, or to a third-party recipient based on the shipping method set by the consumer when the consumer placed the order. In some embodiments, the fulfillment vendor can return created cards to the card processing system 52, and the card processing system 52 can ship the cards as requested by the consumer.

As previously noted, in some embodiments, a consumer or a client can use the consumer-based ordering website 80 and/or the B2B ordering application 82 to check the status of an order. In some embodiments, as the card processing system 52 is processing an order, the consumer-based ordering website 80 and/or the B2B ordering application 82 can display a status, progress, or summary of the process (e.g., percentage complete, total number of records or line items processed, total value successfully loaded, total value amount that could not be successfully loaded, total number of successful operation, total number of failed operations, number of records complete, number of exceptions, etc.). The status of an order can be set to “Not Found,” “Pending,” “In Progress,” “Complete,” etc. In some embodiments, the consumer-based ordering website 80 and/or the B2B ordering application 82 can provide additional information about completed and/or in-process orders, such as submitted time and/or date, completion time and/or date, etc. As previously noted, the system 52 can also automatically inform a client and/or a consumer of the status of an order. For example, the system 52 can send a client or a consumer a message, such as an email message, when an order has been processed, when an order has stalled, when an order has been processing for a longer than normal time, etc.

If the card processing system 52 has completed processing a particular order, a client and/or a consumer can use the consumer-based ordering website 80 and/or the B2B ordering application 82 to view and/or download a log associated with the processed order. The log can indicate a summary of the order processing, such as the total number of records or line items processed, total value successfully loaded to cards, total value amount that could not be successfully loaded to cards, total number of successful operation, total number of failed operations, number of records complete, number of exceptions, etc. In some embodiments, a client and/or a consumer can also use the consumer-based ordering website 80 and/or the B2B ordering application 82 to search and/or sort one or more logs.

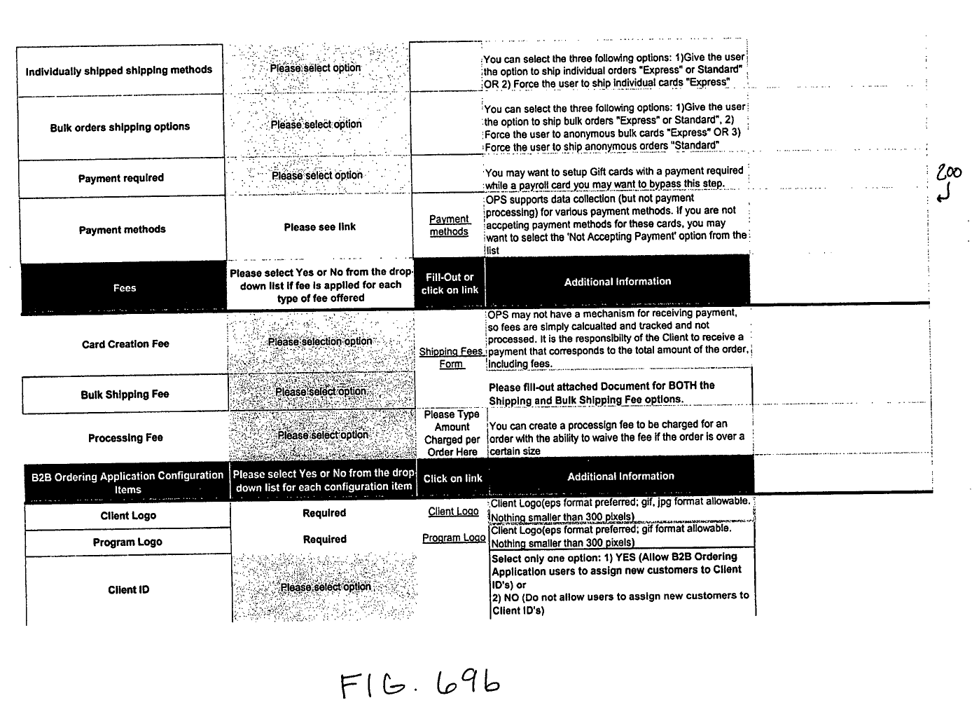

Furthermore, in some embodiments, a client can use the B2B ordering application 82 to check for orders processed by the card processing system 52 that include errors. If an order processed by the card processing system 52 includes errors, the client can review the errors (e.g., by downloading an error file or the order form) and, in some embodiments, can correct and resubmit or re-upload the order form or the portion of the order form that included errors to the system 52. FIG. 67 illustrates further details of the process of reviewing orders with errors using the B2B ordering application 82 according to one embodiment of the invention.

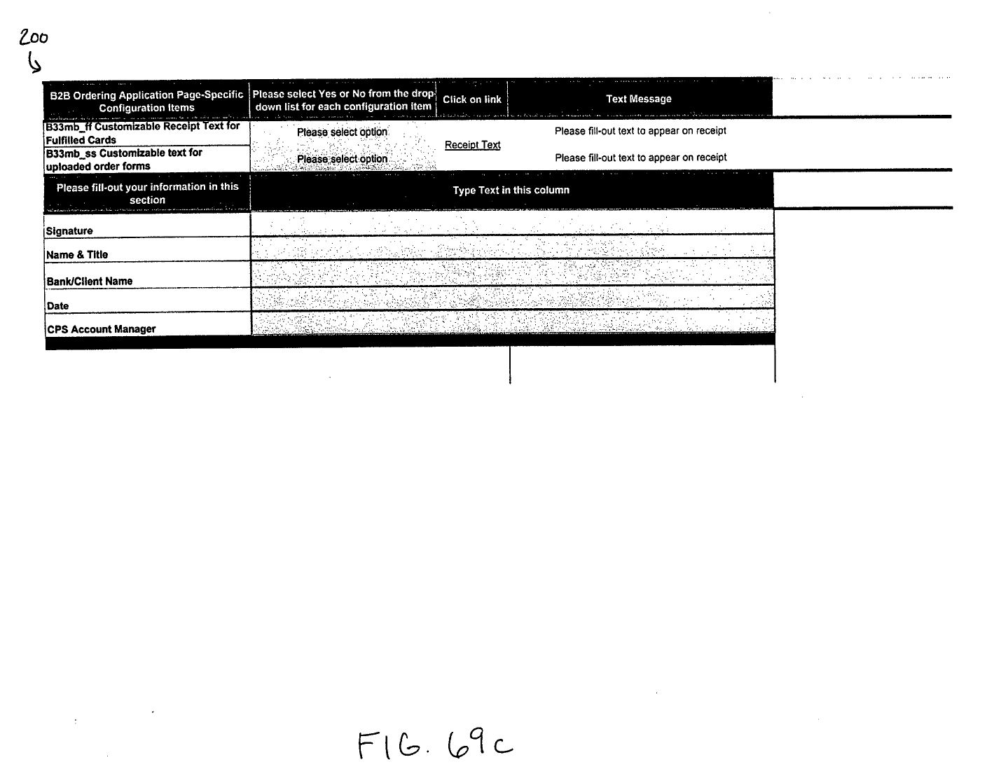

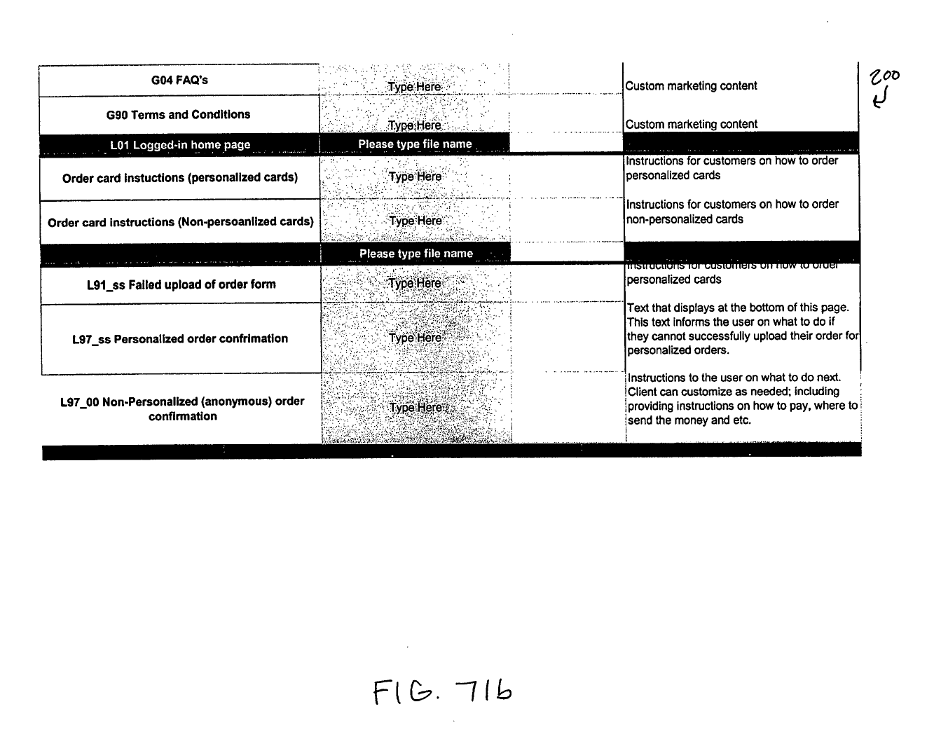

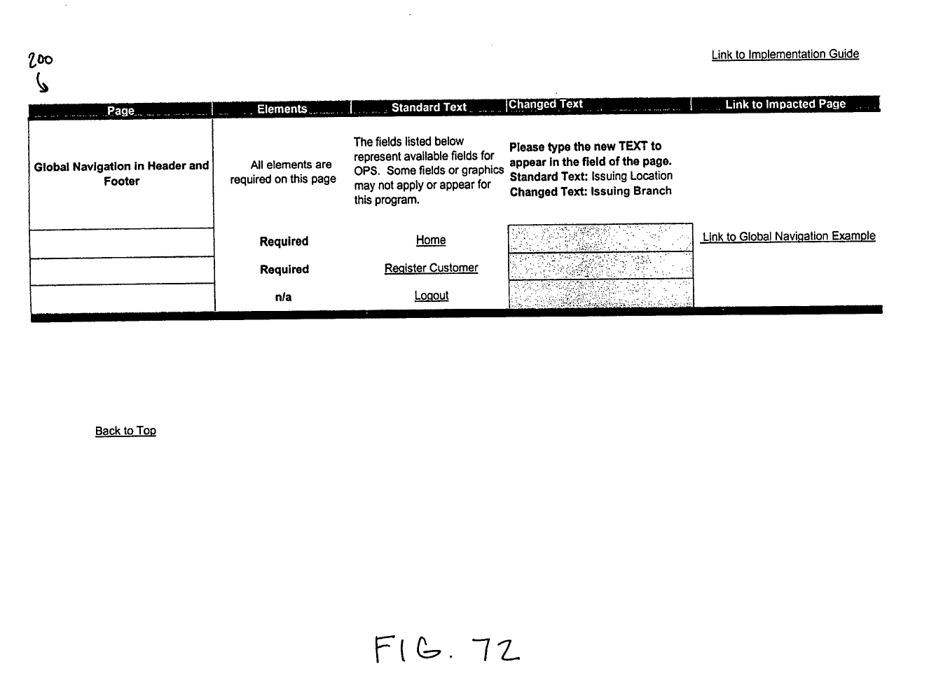

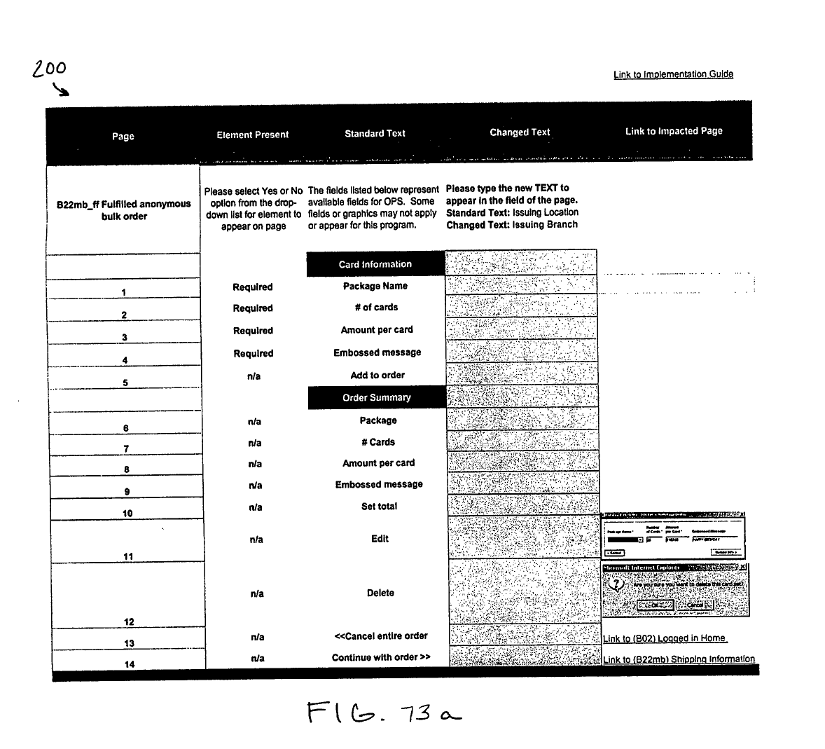

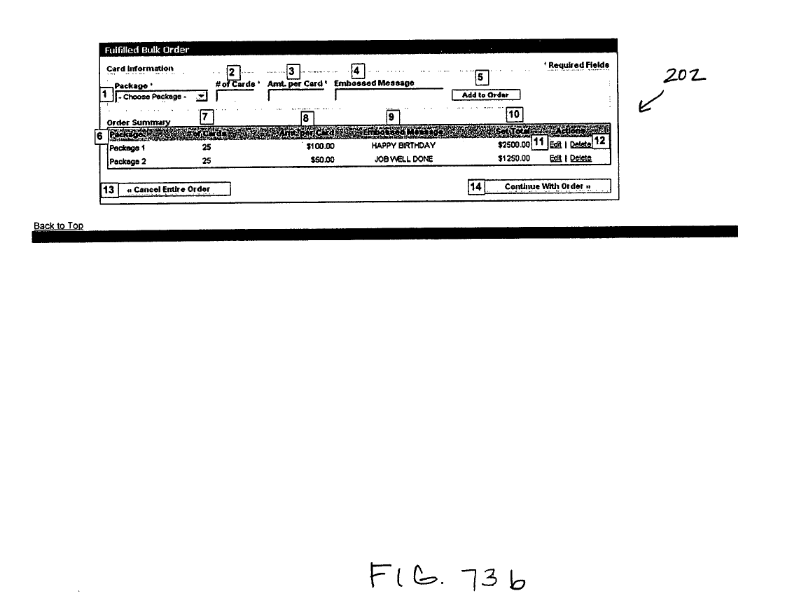

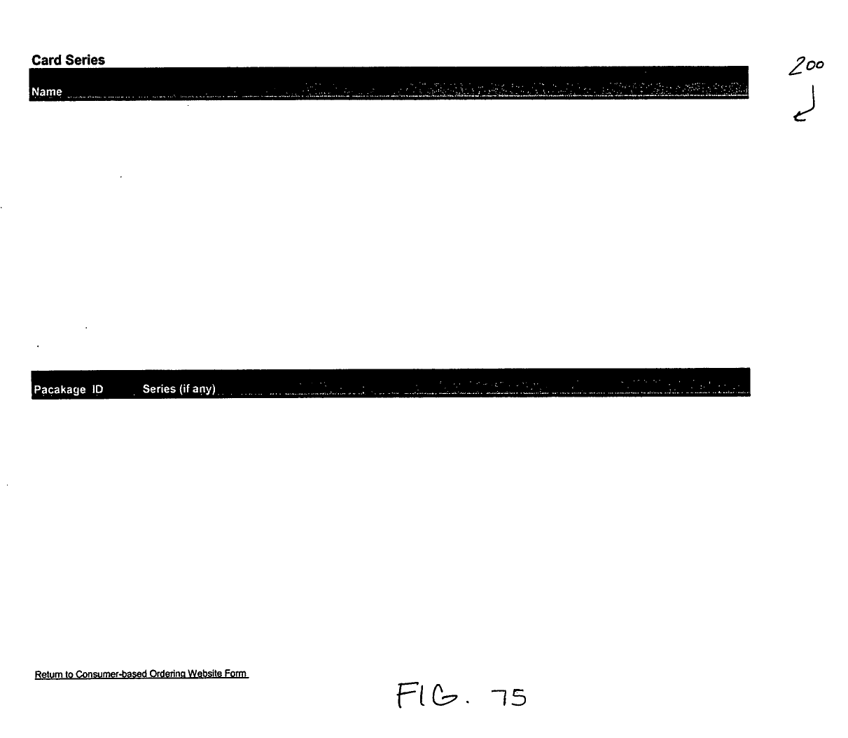

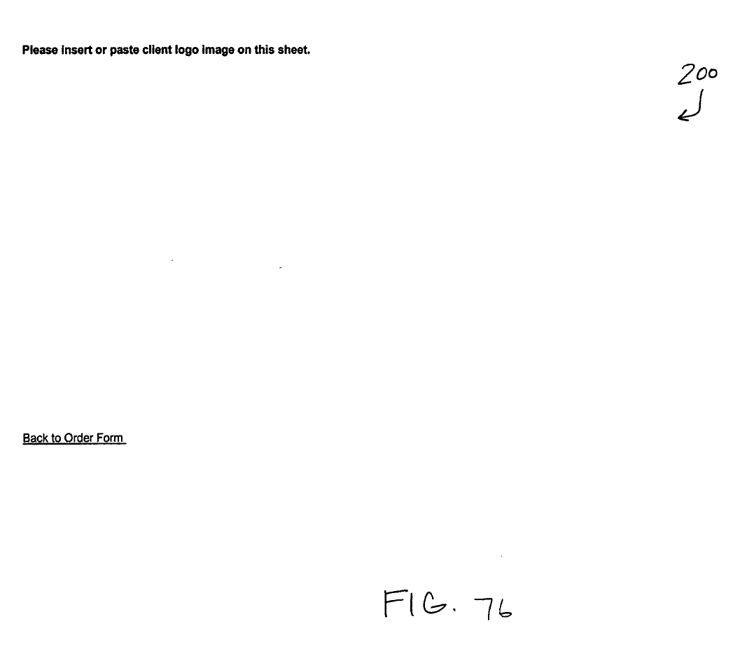

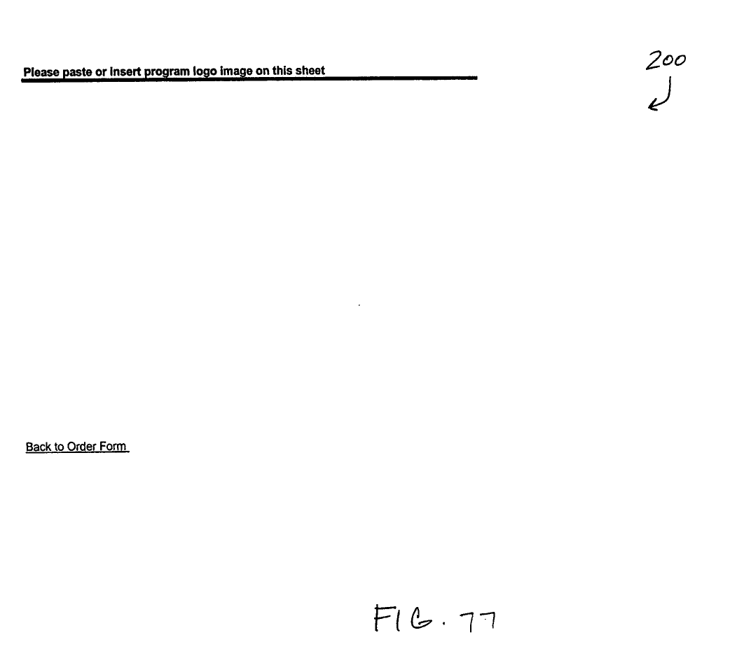

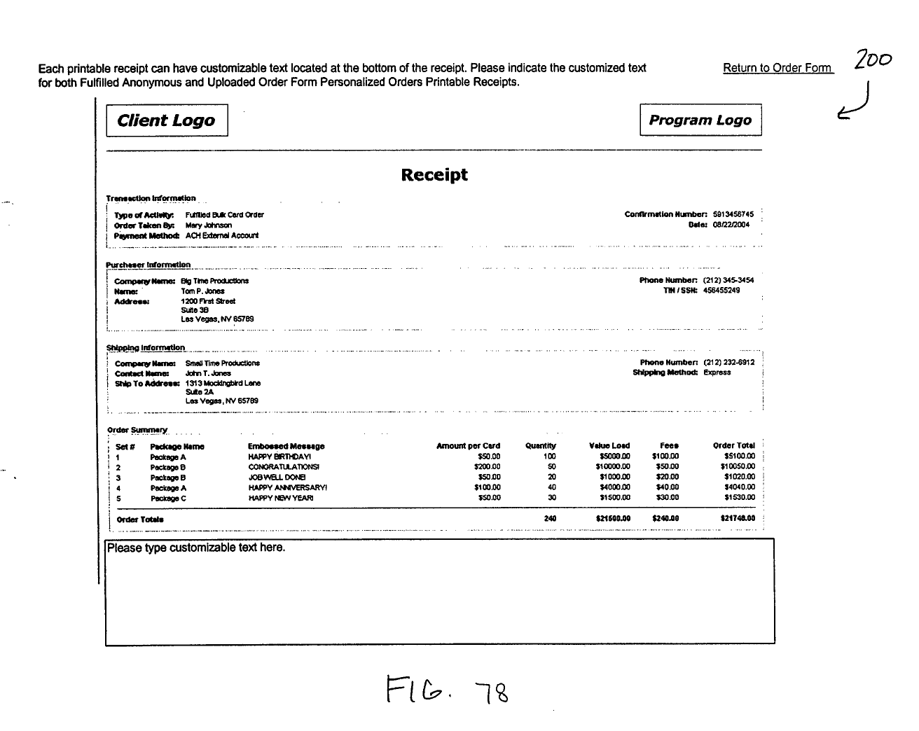

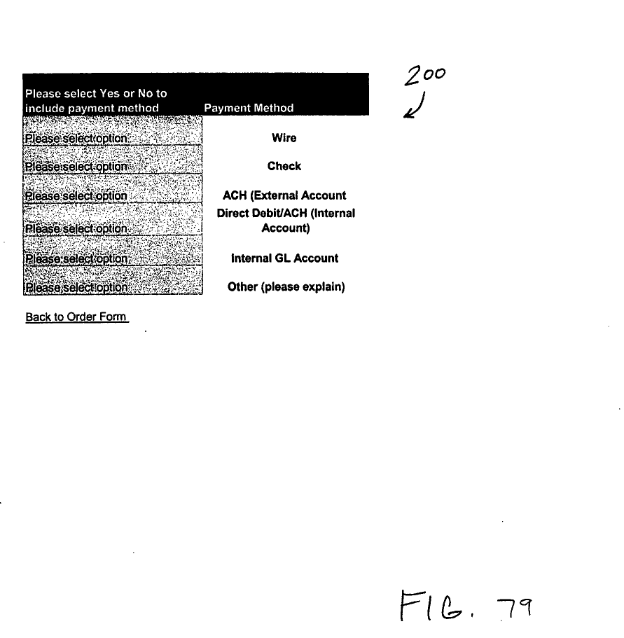

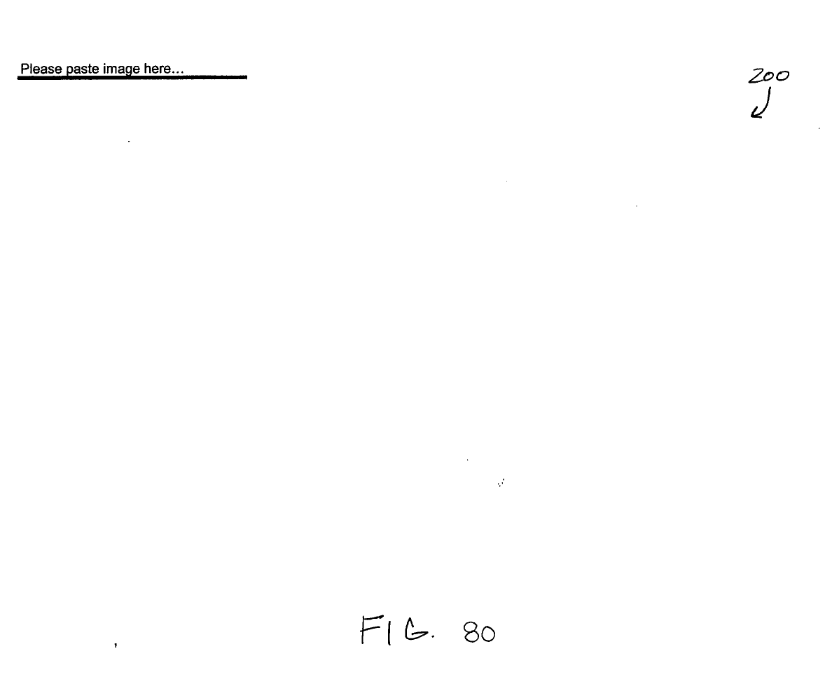

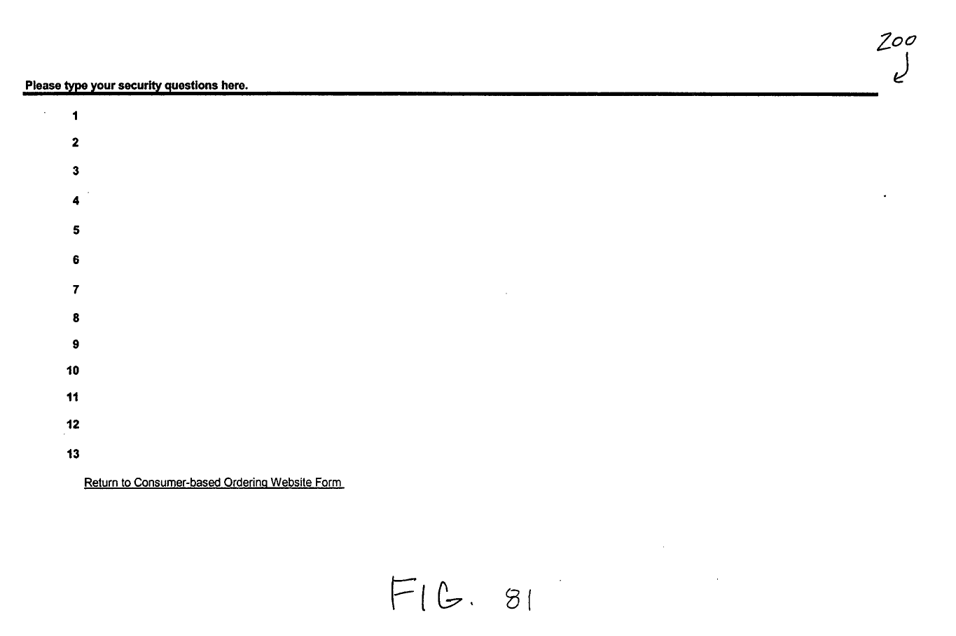

In some embodiments, the downloadable order form 60, as described above with respect to FIGS. 1B and 1C, the screens, pages, and forms displayed by the consumer-based ordering website 80 and/or the B2B ordering application 82, and/or the functionality of the consumer-based ordering website 80 and/or the B2B ordering application 82 can be customized for a particular end user. FIGS. 68-81 illustrate examples of configuration guide forms or worksheets according to embodiments of the invention. An end user (e.g., a consumer or a client) can use the configuration guide forms to indicate customizations for the downloadable order form 60, the consumer-based ordering website 80, and/or the B2B ordering application 82. In some embodiments, data entered in the configuration guide forms can be manually entered into the card processing system 52. In other embodiments, data entered in the configuration guide forms can be automatically processed by the card processing system 52 without (or with a limited amount of) manual intervention.

As shown in FIG. 68, a configuration guide form 200 can list features and/or fields associated with a particular screen, page, form, functionality, or application and the characteristics and/or options of the features and/or fields (e.g., whether the feature is required or optional, default text associated with the feature, etc.). In some embodiments, a configuration guide form 200 can allow a user to change the characteristics of some or all of the features and/or fields associated with a particular screen, page, form, functionality, or application. As shown in FIG. 68, a configuration guide form 200 can also include a sample screen shot 202 of the screen, page, or form. The sample screen shot 202 can display the orientation and design of the features or fields of a particular screen, page, or form. The sample screen shot 202 can also link the features or fields listed in the configuration guide form to their position, orientation, design, and/or use on the screen, page, or form (e.g., via reference numbers).

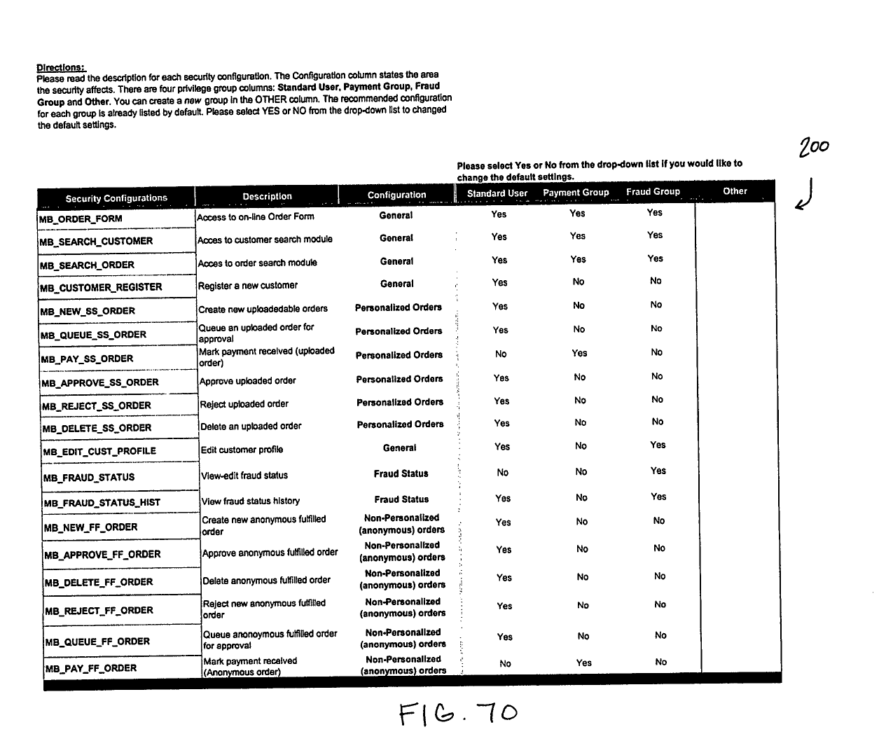

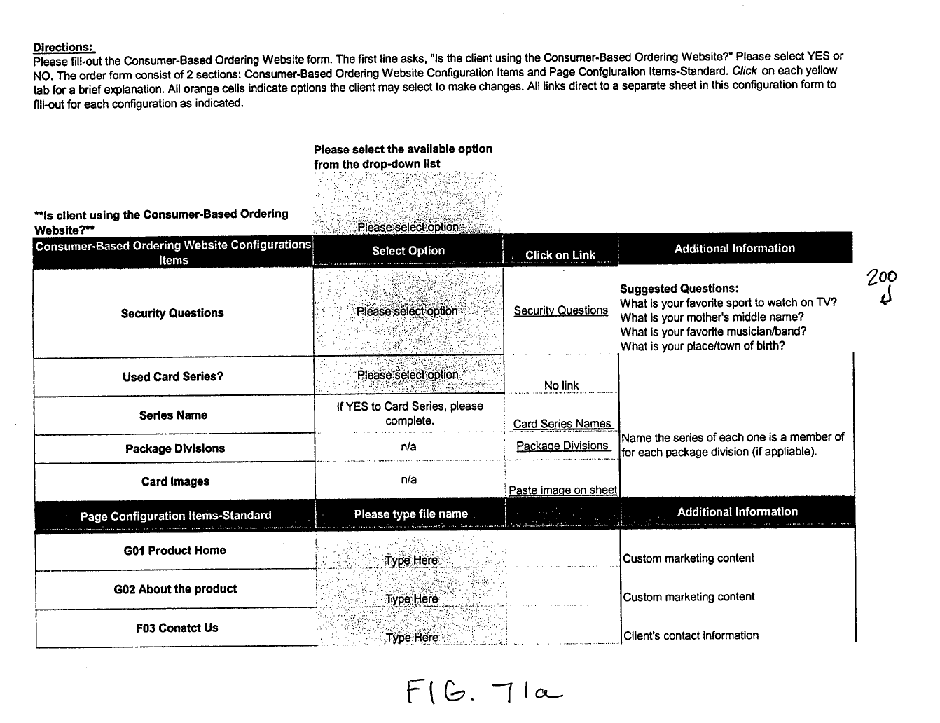

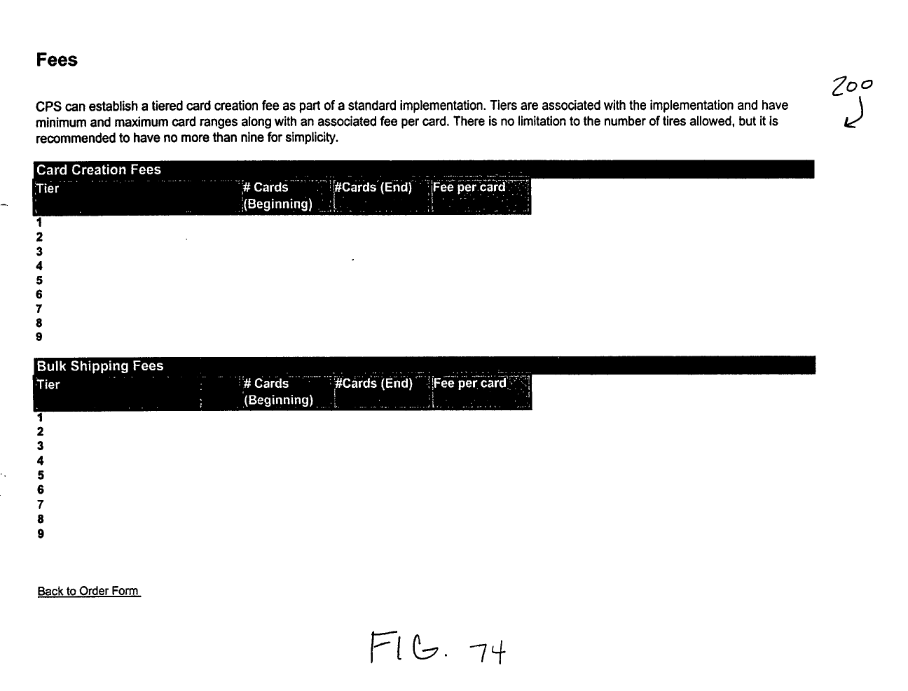

A configuration guide form 200 can allow a user to set various options for screens, pages, forms, functions, or applications. For example, as shown in FIGS. 69A-B, a user can use a configuration guide 200 to select the types of cards offered to a user, the degree of personalization that can be applied to a card by a user, etc. As shown in FIG. 70, in some embodiments, a user can use a configuration form guide 200 to set security settings for users of the system 52, such as setting or selecting screens, pages, forms, and functions accessible to standard users and administrative users. A user can also use a configuration guide form 200, as shown in FIGS. 74-81, to set various other system settings, such as setting card creation and shipment fee schedules, setting available card packages or series, setting logos or customized text, setting accepted payment methods, setting approved security questions, etc.

In some embodiments, other functions performed by the card processing system 52 (e.g., functions performed by the batch system) can be more easily used by clients and/or consumers if clients and/or consumers are provided with pre-formatted forms (e.g., Excel spreadsheets or web pages) where client and/or consumers can create batch instructions without needing to understand or code inputted data to batch specifications. For example, in some embodiments, the card processing system 52 can provide a form for funding source creation; card issues, such as re-issues and ordering dependent and additional cards; card status updates; cashout; gift-giver details; user creation; and other batch functions, which the card processing system 52 can automatically process as described above for the downloadable order form 60.

Various features and advantages of the invention are set forth in the following claims.

1. A method of processing an order for at least one card, the method comprising:
electronically receiving a request for an order form file from a client computer;
electronically transmitting the order form file to the client computer;
electronically receiving the order form file from the client computer, the order form file including data defining an order for at least one card;
automatically validating the data included in the order form file; and
automatically processing the data to fulfill the order.

2. The method of claim 1 and further comprising electronically informing the client computer of at least one error in the data included in the order form file.

3. The method of claim 1 and further comprising electronically prompting the client computer to resubmit the order form file if the data included in the order form file is not validated.

4. The method of claim 1 wherein the order form file includes at least one pre-programmed validation mechanism.

5. The method of claim 1 wherein the at least one card includes at least one of a personalized card and a non-personalized card.

6. The method of claim 1 wherein the at least one card includes at least one of a credit card, a debit card, a stored value card, an identification card, and a gift card.

7. The method of claim 1 and further comprising approving the order.

8. The method of claim 7 wherein approving the order includes automatically approving the order when a payment is received for the order.

9. The method of claim 7 wherein approving the order includes approving the order when a payment is received for the order based on a manual approval received from a client.

10. The method of claim 1 wherein the order form file includes a spreadsheet file.

11. The method of claim 1 wherein the order form file is customized for a particular user operating the client computer.

12. The method of claim 1 and further comprising electronically transmitting a message to the client computer after processing the data.

13. The method of claim 1 and further comprising validating a consumer associated with the order.

14. The method of claim 13 wherein validating a consumer associated with the order includes validating a consumer associated with the order using at least one fraud detection tool.

15. The method of claim 1 and further comprising electronically receiving a request for a status of the order from the client computer and electronically transmitting the status of the order to the client computer.

16. The method of claim 1 wherein automatically validating the data included in the order form file includes validating the data using at least one of a fraud detection system and an identity authentication system.

17. A system for processing an order for at least one card comprising:
a card processing system configured to electronically receive registration information for a user from a client computer; to electronically receive an order form file from the client computer, the order form file including data defining an order from the user for at least one card; to automatically process the data to fulfill the order; and to use the registration information in a subsequent order placed by the user.

18. The system of claim 17 wherein the registration information includes payment information.

19. The system of claim 17 wherein the card processing system is further configured to electronically inform the client computer of at least one error in the data included in the order form file.

20. The system of claim 19 wherein the card processing system is further configured to electronically prompt the client computer to resubmit the order form file if the data included in the order form file is not validated.

21. The system of claim 17 wherein the at least one card includes at least one of a personalized card and a non-personalized card.

22. The system of claim 17 wherein the at least one card includes at least one of a credit card, a debit card, a stored value card, an identification card, and a gift card.

23. The system of claim 17 wherein the card processing system is further configured to automatically approve the order when a payment is received for the order.

24. The system of claim 17 wherein the card processing system is further configured to approve the order when a payment is received for the order based on a manual approval received from a client.

25. The system of claim 17 wherein the card processing system is further configured to validate the registration information.

26. The system of claim 25 wherein the card processing system validates the registration information using at least one fraud detection tool.

27. A computer readable medium including instructions for processing an order for at least one card, the instructions comprising:
receiving a request for an order form file from a client computer;
transmitting the order form file to the client computer;
receiving the order form file from the client computer, the order form file including data defining an order for at least one card;
approving the order; and
automatically processing the data to fulfill the order.

28. The computer readable medium of claim 27 and further comprising instructions for informing the client computer of at least one error in the data included in the order form file.

29. The computer readable medium of claim 27 and further comprising instructions for prompting the client computer to resubmit the order form file if the data included in the order form file is not validated.

30. The computer readable medium of claim 27 wherein the instructions for approving the order include instructions for automatically approving the order when a payment is received for the order.

31. The computer readable medium of claim 27 wherein the instructions for approving the order include instructions for approving the order when a payment is received for the order based on a manual approval received from a client.

32. The computer readable medium of claim 27 and further comprising instructions for transmitting a message to the client computer after processing the data.

33. The computer readable medium of claim 27 and further comprising instructions for validating a consumer associated with the order.

34. The computer readable medium of claim 33 wherein the instructions for validating a consumer associated with the order include instructions for validating a consumer associated with the order using at least one fraud detection tool.

35. The computer readable medium of claim 27 and further comprising instructions for receiving a request for a status of the order from the client computer and for transmitting the status of the order to the client computer.
